(19) United States
(12) Patent Application Publication
(10) Pub. No.: US 2023/0302597 A1
(43) Pub. Date: Sep. 28, 2023

(54) CAROUSEL-TYPE SINGLE-SPINDLE MULTI-TASK DEVICE

(71) Applicant: SETI-TEC, COLLEGIEN (FR)

(72) Inventor: Sebastien PEREIRA-SANTO, CHARNECA DA CAPARICA (PT)

(21) Appl. No.: 18/004,245

(22) PCT Filed: Jul. 7, 2020
(86) PCT No.: PCT/EP2020/069158

§ 371 Date: Jan. 4, 2023

(51) Int. Cl. B23Q 39/02

(52) U.S. Cl. CPC B23Q 39/024; B23Q 2039/004

(57) ABSTRACT

A multi-task device includes an element for securing the device to a motorized handler; an element for securing the device to a structure that is to be worked; at least two functional modules, each including at least one mobile member able to allow a given task to be accomplished; and a single drive and control assembly for driving and controlling the functional modules. The drive and control assembly includes: a single drive spindle; a drive capable of driving the movement of the spindle; a measurement element measuring at least one physical parameter indicative of at least one characteristic of operation of the functional modules; and a controller controlling the drive and the measurement element. The device further includes a coupling gear able to connect the single drive spindle, for the purposes of transmitting movement, alternatively to the at least one mobile member of the functional modules.

### CROSS-REFERENCE TO RELATED APPLICATIONS

This Application is a Section 371 National Stage Application of International Application No. PCT/ PCT/EP2020/069158, filed Jul. 7, 2020, which is incorporated herein by reference in its entirety and published as WO 2022/008039 A1 on Jan. 13, 2022, not in English.

### 1. FIELD OF THE INVENTION

The field of the invention is that of the design and production of devices implemented in industry to carry out various tasks on a structure that is to be worked, in particular for the aeronautical industry.

### 2. PRIOR ART

Many devices are commonly implemented to carry out different tasks or operations on a structure that is to be worked. This may, for example, be drilling, countersinking, setting a temporary fastening, coating a rivet with mastic then setting this rivet into a hole drilled in said structure or any other operation.

Mobile devices have been developed to allow carrying out tasks on complex structures such as, for example, aircraft.

These devices include in particular those of the type comprising a tooling placed at the end of a robot arm to be manipulated and displaced relative to the structure that is to be worked, the device comprising means allowing making the tooling secured to the structure that is to be worked in order to make it resume the forces due to the accomplishment of the task to relieve the robot arm.

The patent document US 5 088 171 describes a device of this type comprising a drilling machine placed at the end of a robot arm and comprising means allowing snap-fitting the tooling with the surface of the structure that is to be worked to make them secured, for the time necessary to accomplish a task.

There are also known devices of the type comprising a tooling secured to a robot called “walking” robot, in particular a hexapod, allowing manipulating and moving the tooling relative to the structure that is to be worked.

The patent document FR-B1-2 809 034 describes a device of this type comprising a drilling machine mounted on a hexapod robot and which comprises suction cups to allow making the structure that is to be worked alternately secured to the robot and the tooling.

There are also known devices of the type comprising a frame integrating orthogonal rails (an x-rail and a y-rail) which can be secured to the structure that is to be worked by means of suction cups. These rails allow guiding the tooling, in a motorised manner, relative to the structure that is to be worked to allow accomplishing tasks successively at different locations of this structure. This type of devices is generally called a “digital grid” or “digital drilling grid” if they are used to make bores.

The patent document WOA-2-200349899 describes a device of this type.

These types of devices are advantageous in that they allow intervening effectively to carry out tasks on complex structures such as, in particular, aircraft fuselages.

They still allow relieving the moving means implemented to move the tooling (robot, actuators, motorisations, gearing systems, etc.) taking into account the implementation of means allowing securing the tooling to the structure that is to be worked (suction cups, mechanical connection system, ...). This allows reducing the sizing of these moving means and thus reducing their space requirement and cost.

The means for securing the tool to the structure that is to be worked also allow improving the stability of the tooling during the performance of a task and thus improving the accuracy with which this task is accomplished.

Nevertheless, these types of devices have some drawbacks.

In particular, they are not very versatile. Indeed, they only on-board one type of tooling, for example a drilling device, so that they only allow carrying out one type of task, in this case drilling. Thus, if it is desired to carry out, on the same structure, several types of tasks, for example a drilling then setting a rivet, it is necessary to proceed with the disassembly of the first tooling after carrying out the first task to replace it with another tool capable of carrying out the following task. This is rather impractical and leads to a decrease in productivity.

Solutions have been devised to on-board several types of toolings, in particular at the end of a robot arm. However, the devices of this type are bulky, complex and expensive to implement.

It is therefore still possible to improve the devices of this type, which constitutes an objective pursued by the invention.

### 3. SUMMARY

To this end, the invention proposes a multi-task device comprising:
means for securing said device to motorised handling means able to move said multi-task device at least partially in space with respect to a structure that is to be worked;
means for securing said device to said structure that is to be worked;
at least two functional modules, each of said functional modules comprising at least one mobile member able to allow a given task to be accomplished.

Such device comprises a single drive and control assembly for driving and controlling said functional modules, said drive and control assembly comprising:
a single drive spindle;
drive means capable of driving the movement of said spindle;
measurement means measuring at least one physical parameter indicative of at least one characteristic of operation of said functional modules;
control means controlling said drive means and said measurement means.

Such a device further comprises coupling gear able to connect said single drive spindle, for the purposes of transmitting movement, alternately to said at least one mobile member of said functional modules.

Thus, according to this aspect, the invention proposes a multi-task device that can be secured to a structure that is to be worked, for example by suction cups, and moved relative to this structure by motorised handling means such as a robot arm, a walking robot or a digital grid. This device is multi-task in that it on-boards several functional modules each allowing the performance of a distinct type of task such as for example drilling, countersinking, coating of mastic on an assembly element such as a rivet or a screw, rivet setting, setting of a temporary fastening (for example of a clip) ···.

Such a device is particularly original in that it comprises a single drive and control assembly for driving and controlling the functional modules.

This drive and control assembly comprises in particular a single drive spindle and drive means for driving the movement of said spindle.

The device comprises coupling gear capable of connecting the single drive spindle, for the purposes of transmitting movement, alternately to a mobile member of the on-board functional modules. Thus, the functional modules do not comprise a motorisation. They are each driven to move, alternately by means of the same spindle and the same motorisation of the single drive and control assembly.

Similarly, the single drive and control assembly comprises means for measuring at least one physical parameter indicative of at least one characteristic of operation of the functional modules and means for controlling the drive means and measurement means so that the “intelligent” portion of the device is integrated, at least for the most part, in the single drive and control assembly, so that the functional modules only include the essential elements required for carrying out their function, i.e. its output member(s) as well as the mechanical elements allowing transferring, and where appropriate modifying, the movement of the spindle to its output member(s).

The functional modules, according to the invention, thus have an extremely simple architecture. They are therefore particularly robust. They are further compact and lightweight. This allows on-boarding a large number of functional modules without requiring excessively large handling means, which would have an impact on the general space requirement of the device and on its cost.

The use of a single drive and control assembly grouping together all drive means, measurement means and control means as well as a single drive spindle which are used to drive each of the functional modules, allows reducing the number of implemented components, simplifying the architecture, thus improving in particular the robustness, the reliability and the compactness of the device.

A device according to the invention thus benefits from a great versatility, which contributes to increasing productivity, a good compactness, which allows carrying out tasks in cramped environments, a great simplicity and robustness, which reduces the frequency of the maintenance operations and participates in increasing productivity, and from a certain lightness which allows in particular reducing the sizing of the handling means.

According to one possible feature, said coupling gear ensure a direct connection between said spindle and said at least one mobile member of the coupled functional module.

According to one possible feature, a device according to the invention comprises means for transforming movement between said spindle and said at least one mobile member of said coupled functional module.

According to one possible feature, said motorised handling means belong to the group comprising:
the robots;
the digital drilling grids.

According to one possible feature, said measurement means are capable of measuring at least one parameter indicative of at least one characteristic of operation of said functional modules belonging to the group comprising:
a torque on said at least one mobile member of the coupled module;
an axial force on said at least one mobile member of the coupled module;
an angular position of said at least one mobile member of the coupled module;
an axial position of said at least one mobile member of the coupled module. According to one possible feature, said drive means comprise at least one electric motor capable of driving the movement of said spindle and said at least one mobile member of a functional module coupled to said spindle.

According to one possible feature, said control means comprise means for measuring the electrical intensity consumed by said motor and means for determining, depending on the measured electrical intensity, a torque and/or an axial force on said at least one mobile member of a coupled module.

According to one possible feature, said at least one motor comprises a rotor, said measurement means comprising at least one sensor for measuring the angular position of said rotor, said control means comprising means for determining, depending on the angular position of said measured rotor, the angular position and/or the axial position of said at least one mobile member of a functional module coupled to said spindle.

According to one possible feature, said drive means comprise a gearing system connecting said at least one motor to said single drive spindle, said measurement means comprising at least one torque and/or force and/or position sensor which are integrated into said gearing system capable of allowing the determination of a torque and/or an axial force on said at least one mobile member of a coupled module and/or of an angular and/or axial position of said at least one mobile member of a coupled module.

According to one possible feature, a device according to the invention comprises means for routing said functional modules in the extension of said drive spindle.

According to one possible feature, said routing means comprise at least one carousel which is mounted movable in rotation and comprising means for supporting a plurality of functional modules.

According to one possible feature, a device according to the invention comprises means for driving in rotation said at least one carousel, said rotational drive means comprising at least one mobile drive pawl forming with said carousel a ratchet wheel type assembly, said rotational drive means comprising means for moving said mobile drive pawl along an axis orthogonal to the axis of rotation of said carousel.

According to one possible feature, said routing means comprise at least one support member which is movable in translation and comprising means for supporting a plurality of functional modules.

According to one possible feature, a device according to the invention comprises means for remotely activating-deactivating said coupling gear.

According to one possible feature, said drive spindle is mounted movable in rotation and in translation along the same axis, said drive means comprising at least one motor and one gearing system connecting said drive spindle to said at least one motor, said gearing system comprising:
a rotational drive yoke comprising a splined portion of complementary shape to a splined portion formed on said spindle along said axis;
a translational drive ring connected to said drive spindle by a helical connection along said axis.

According to one possible feature, a device according to the invention comprises at least one pressing element, capable of exerting a pressure on said structure that is to be worked, located in the extension of said drive spindle, and means for moving said pressing element in the direction of said structure that is to be worked, said means for moving said pressing element acting on said pressing element via a functional module located in the extension of said spindle.

According to one possible feature, a device according to the invention comprises at least one of said functional assemblies comprises a sheath slidably housing a functional assembly, said functional assembly further comprising means for blocking in translation said functional assembly in said sheath.

### 4. DESCRIPTION OF FIGURES

Other features and advantages of the invention will appear on reading the following description of particular embodiments, given by way of simple illustrative and non-limiting example, and the appended drawings, among which:

FIG. 1 illustrates a perspective view of a device according to the invention;

FIG. 2 illustrates a sectional view of the device of FIG. 1 along a plane passing through the axis of the spindle;

FIG. 3 illustrates an enlarged partial view of FIG. 1;

FIG. 4 illustrates a view of the device of FIG. 1 along the plane A-A of the device of FIG. 3;

FIG. 5 illustrates a first variant of device of suction pads for securing a device according to the invention to a structure that is to be worked;

FIG. 6 illustrates a partial and sectional view along a plane passing through the spindle and the rotating guide shaft of the carousel of a device according to the invention;

FIG. 7 illustrates a perspective view of a rotating guide shaft of the carousel of a device according to the invention;

FIG. 8 illustrates a sectional view of a rivet support module;

FIG. 9 illustrates a sectional view of another rivet support module;

FIG. 10 illustrates a sectional view of a drilling module;

FIG. 11 illustrates a sectional view of a temporary fastening support module;

FIG. 12 illustrates a sectional view along the plane D-D of the device of FIG. 2;

FIG. 13 illustrates a sectional view along the plane E-E of the device of FIG. 2;

FIG. 14 illustrates a sectional view along the plane B-B of the device of FIG. 2;

FIG. 15 illustrates a sectional view along the plane C-C of the device of FIG. 2;

FIG. 16 illustrates a perspective partial and sectional view along a plane passing through the axis of rotation of the carousel of a device according to the invention;

FIG. 17 illustrates the device of FIG. 1 from another angle of view;

FIG. 18 illustrates the device of FIG. 17 with a different suction device;

FIG. 19 illustrates an example of a C-clamp implemented for securing a device according to the invention to a structure that is to be worked;

FIG. 20 illustrates the device of FIG. 19 from another angle of view;

FIG. 21 illustrates a section along the H-H axis of FIG. 20;

FIG. 22 illustrates a detail of FIG. 21;

FIG. 23 illustrates a partial view of a universal securing device according to the invention;

FIG. 24 illustrates a perspective detail view of the device of FIG. 1 at the secondary carousel;

FIG. 25 illustrates a sectional view along the I-I axis of the secondary carousel;

FIG. 26 illustrates a sectional view along the J-J axis of the secondary carousel;

FIG. 27 illustrates a partial view in longitudinal section of the device at the quick coupling gear;

FIG. 28 illustrates a sectional view along the K-K axis of FIG. 27;

FIG. 29 illustrates a sectional view along the H-H axis of FIG. 4;

FIG. 30 illustrates a sectional view of a male element of the coupling gear;

FIG. 31 illustrates a sectional view along a 90° section plane of FIG. 30;

FIG. 32 illustrates a top view of a locking member;

FIG. 32 illustrates a side view of a locking member 28;

FIG. 34 illustrates a partial sectional view of the coating station;

FIG. 35 illustrates a partial sectional view along the M-M axis of FIG. 34;

FIG. 36 illustrates a partial sectional view of a rivet support module at the coating station;

FIG. 37 illustrates the lead screw and coating station shoe;

FIG. 38 illustrates a detail view of the coating station;

FIG. 39 illustrates a variant of coating station;

FIG. 40 illustrates a detail of FIG. 39;

FIG. 41 illustrates another detail of FIG. 39;

FIG. 42 illustrates a longitudinal sectional view of a rivet support module of a given size during coating;

FIG. 43 illustrates a longitudinal sectional view of a rivet support module of a given size different from that of FIG. 42 during coating, whose zone of connecting the head and the body is located at the same relative position with respect to the nozzle as with the module in FIG. 42;

FIG. 44 illustrates a longitudinal sectional view at the temporary fastening loading station;

FIG. 45 illustrates views of a locking element;

FIG. 46 illustrates a detail of FIG. 44;

FIG. 47 illustrates a partial view in longitudinal section of the perspective workstation;

FIG. 48 illustrates a partial view in longitudinal section of the workstation at the quick coupling gear;

FIG. 49 illustrates a partial view in longitudinal section of the means for connecting in translation the main and secondary spindles;

FIG. 50 illustrates views illustrating telescopy.

### 5. DESCRIPTION OF PARTICULAR EMBODIMENTS

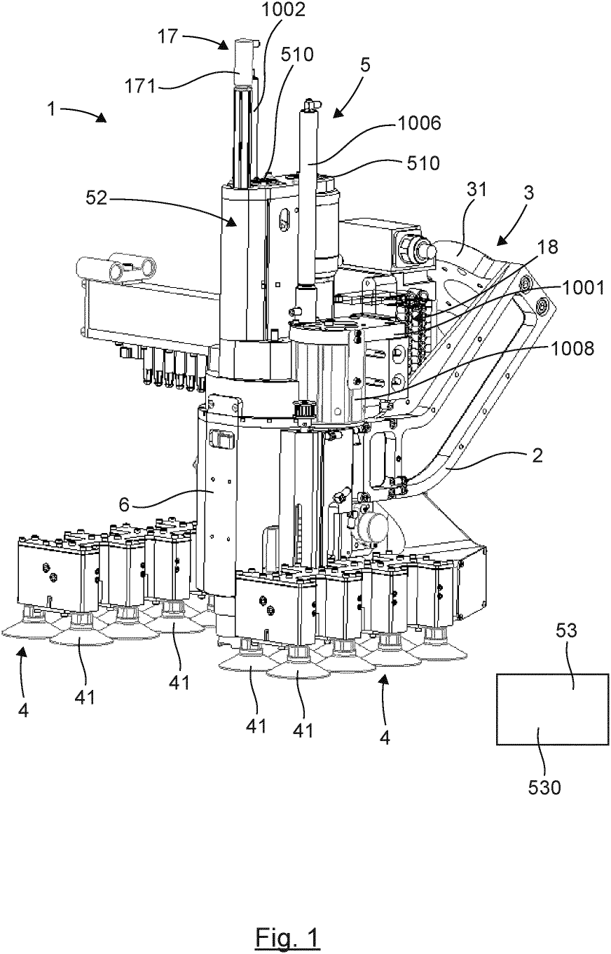

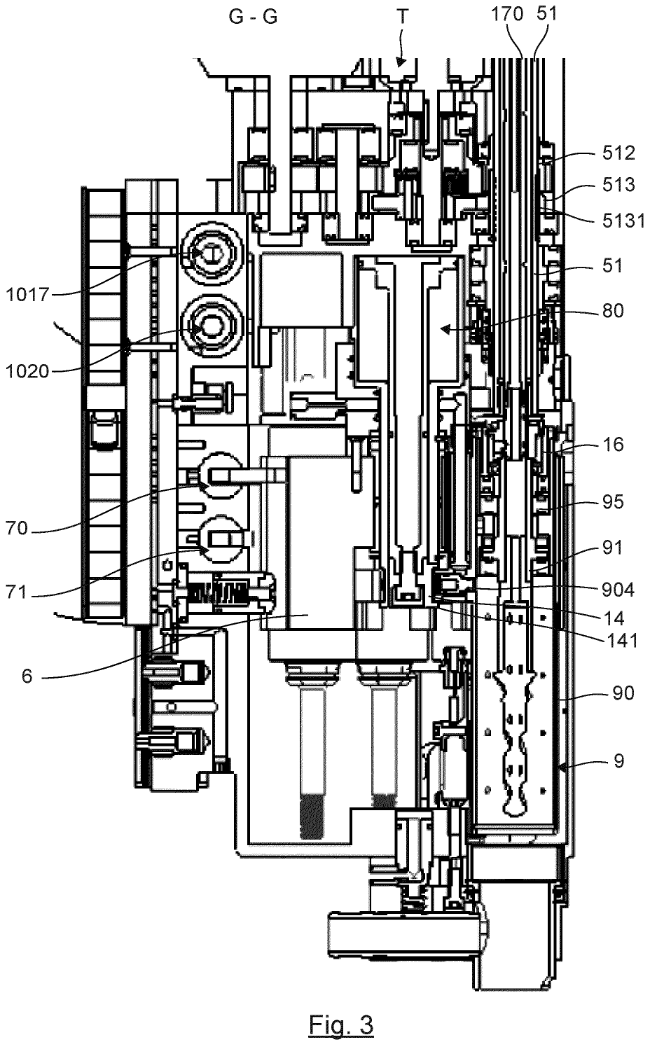

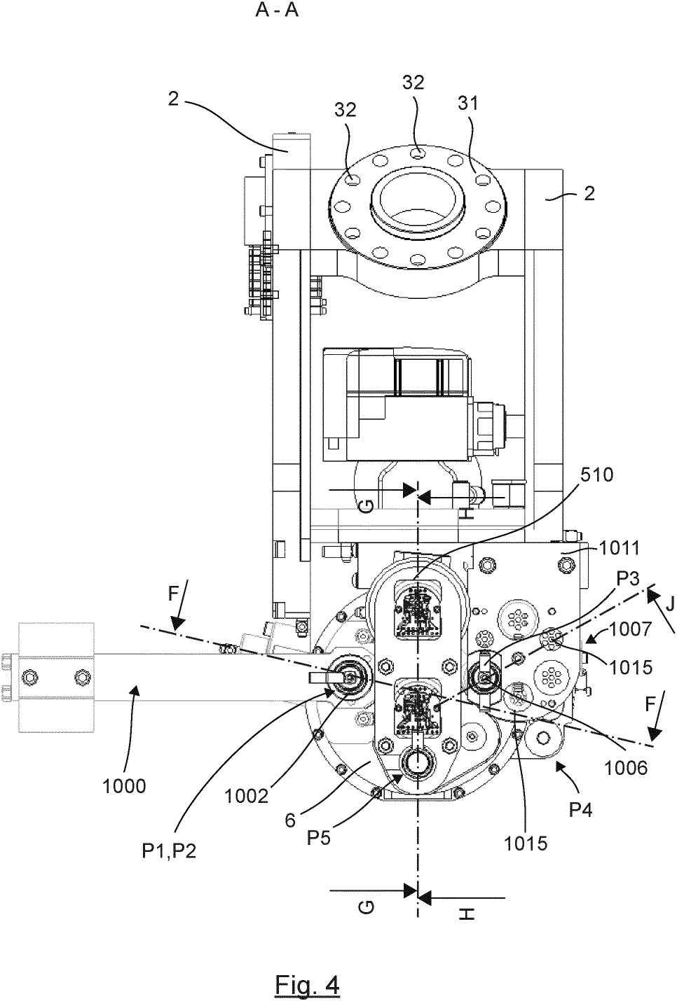

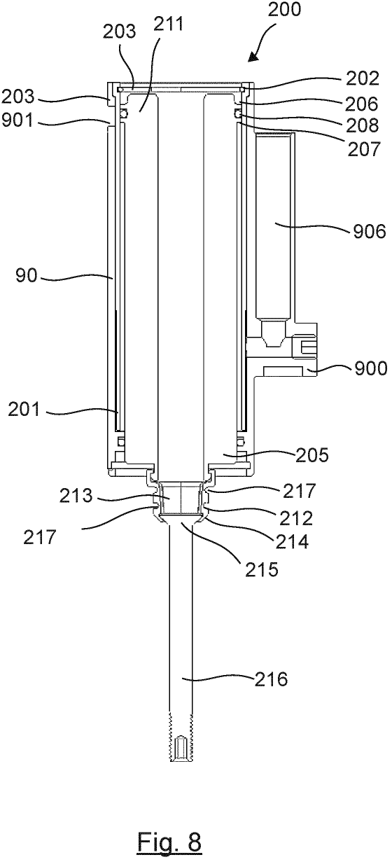

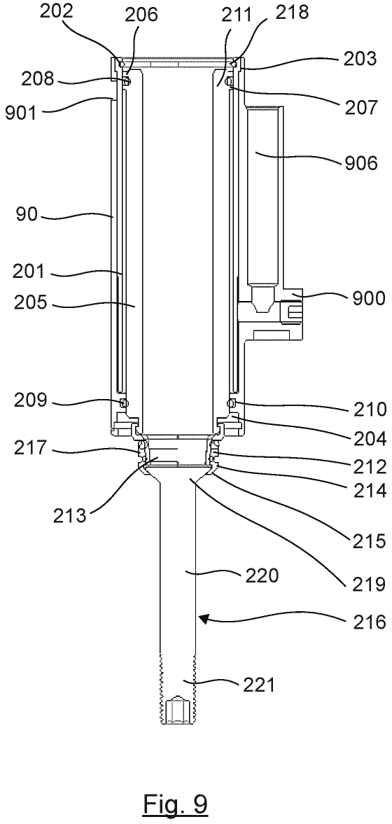

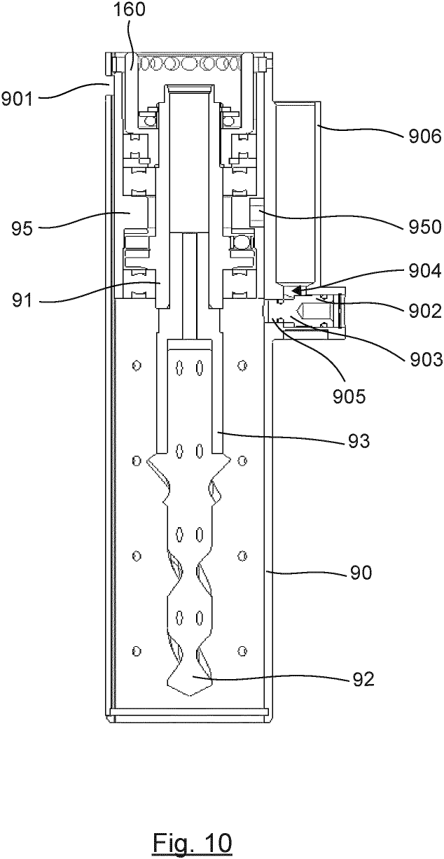

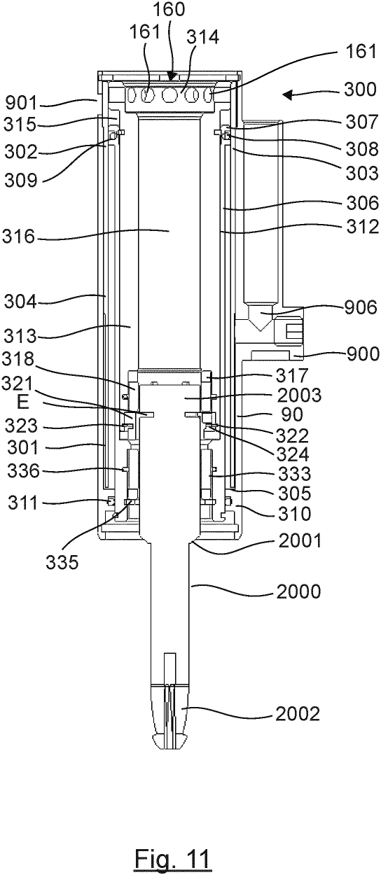

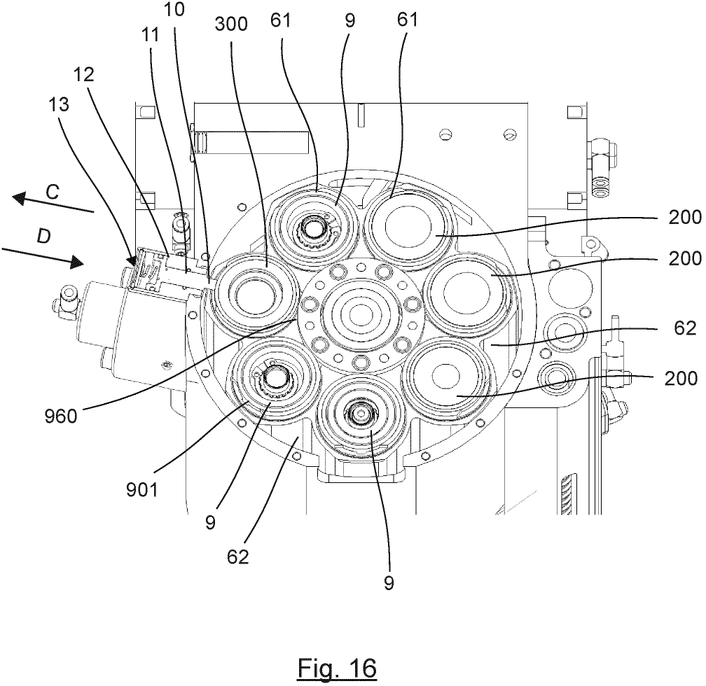

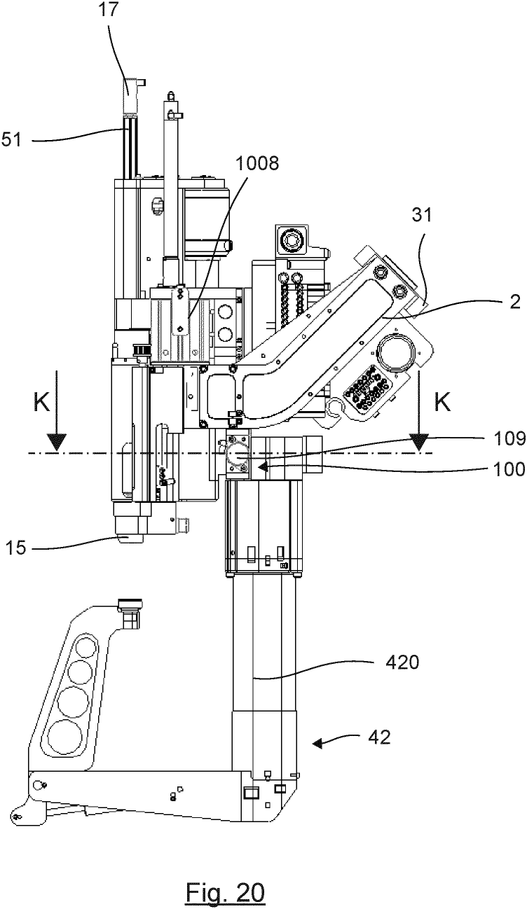

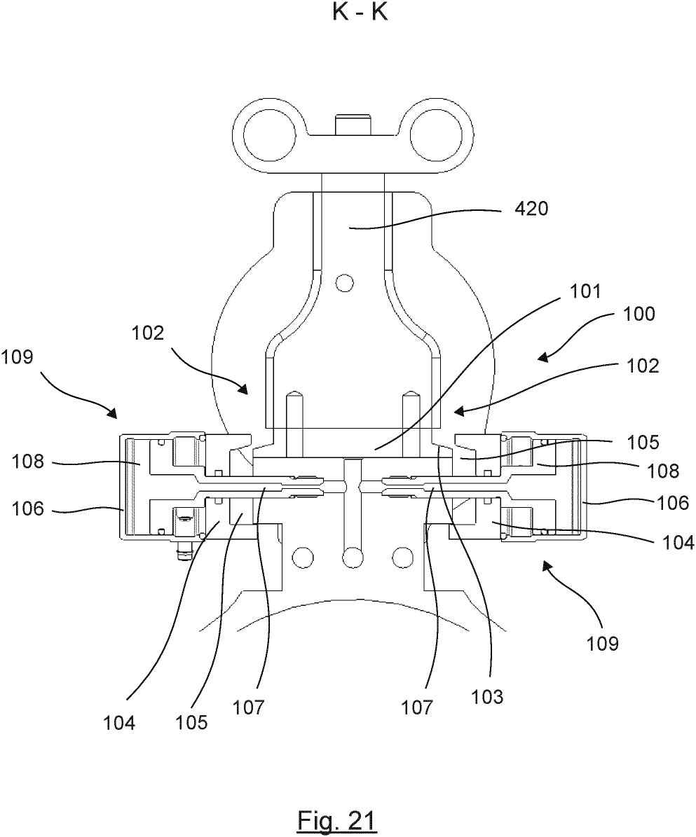

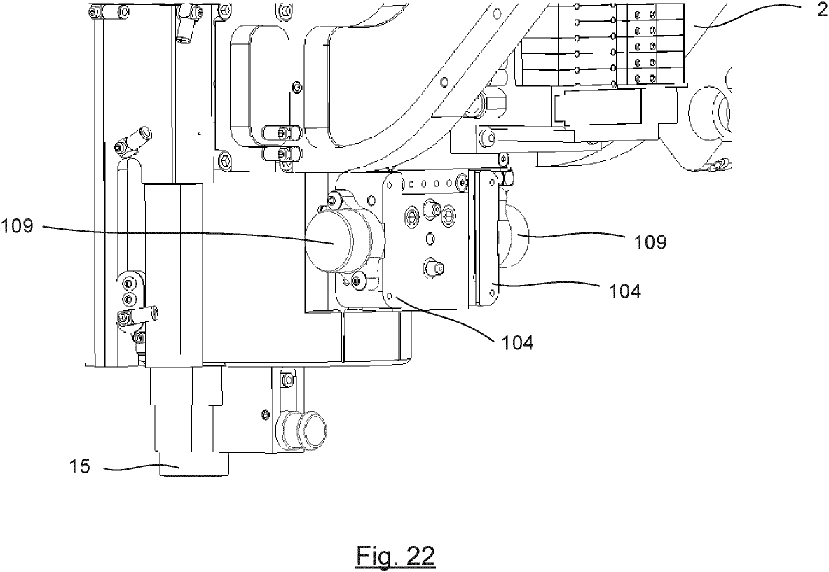

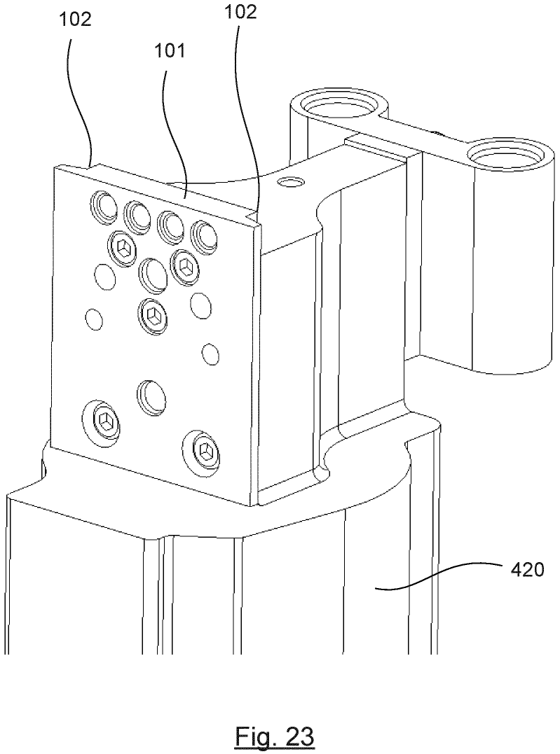

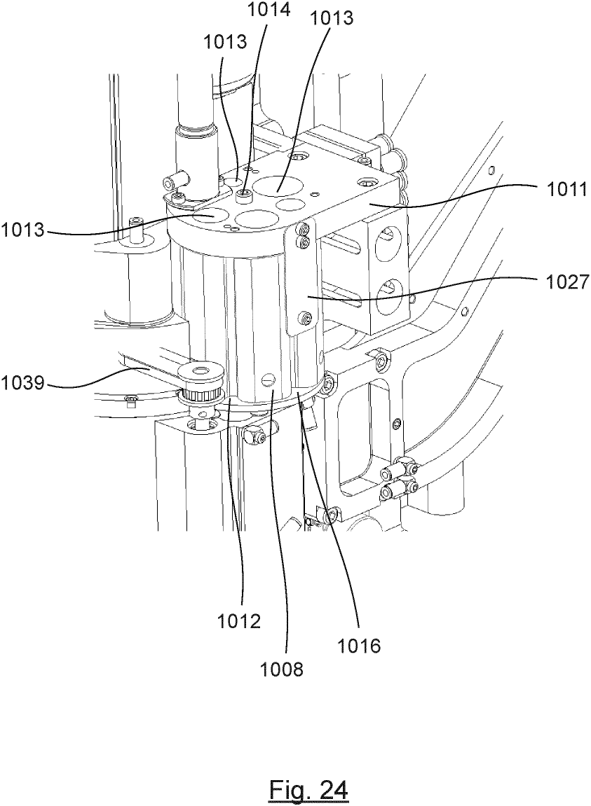

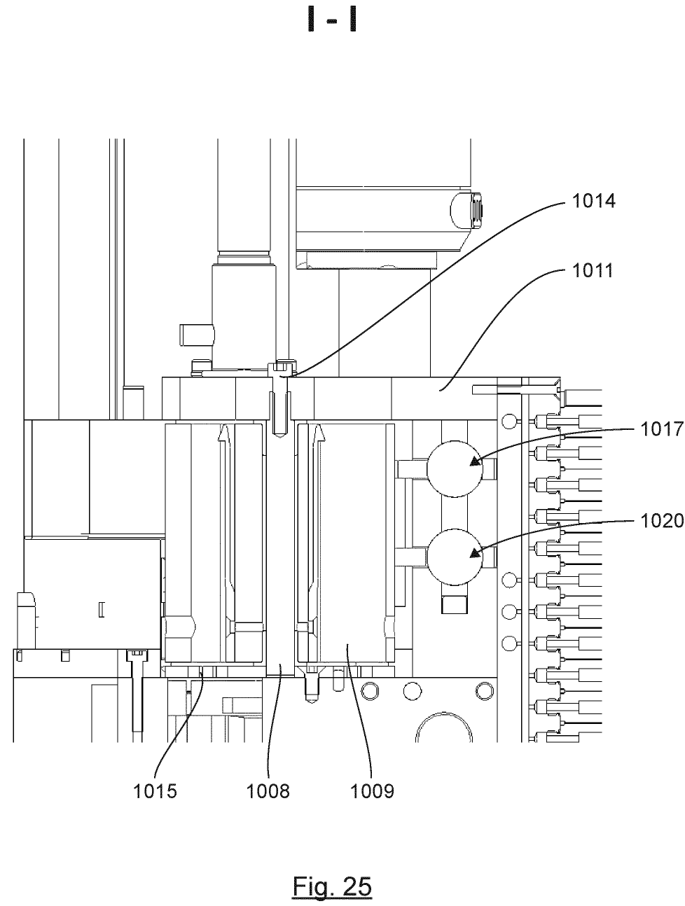

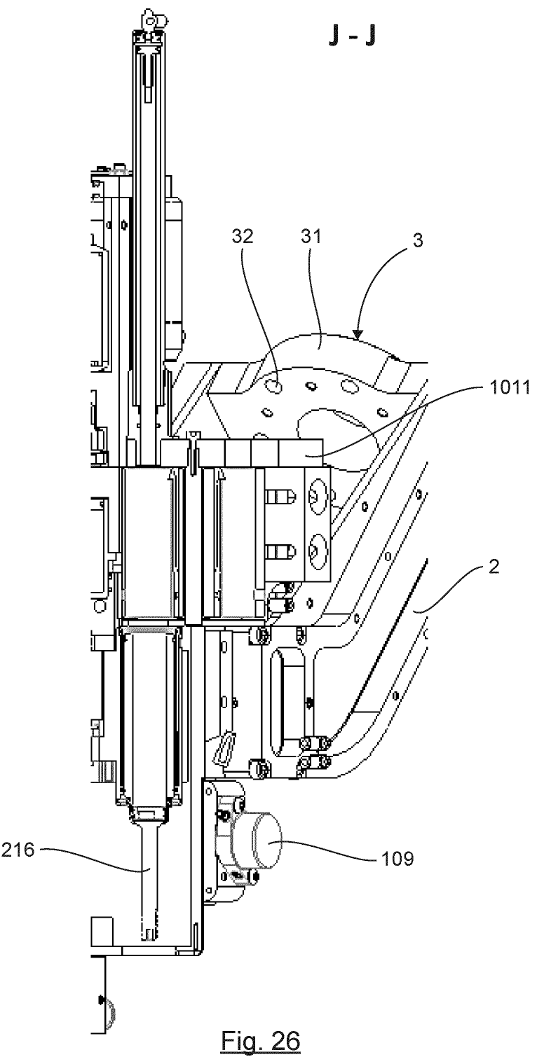

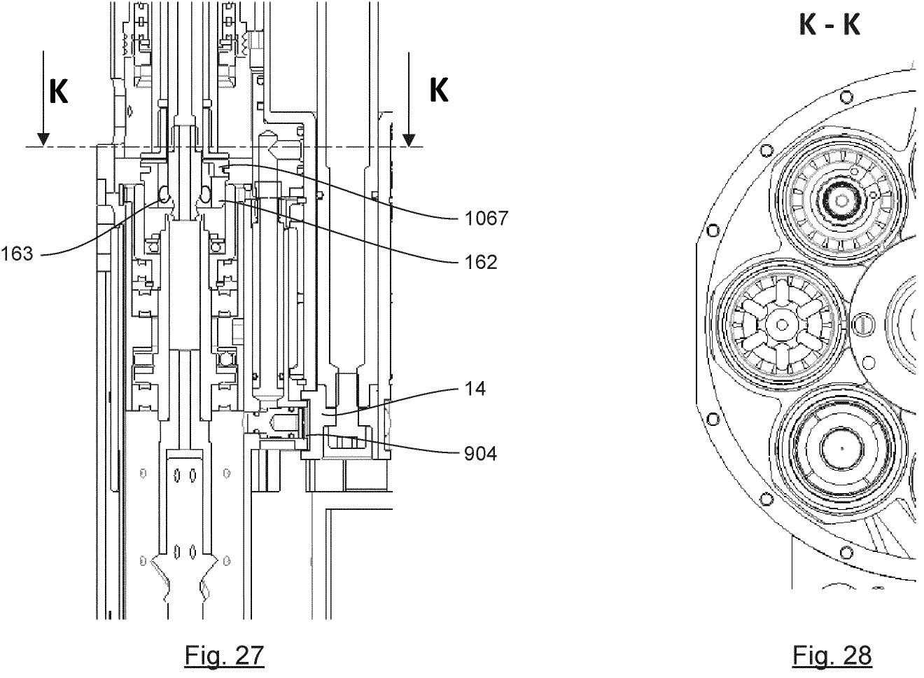

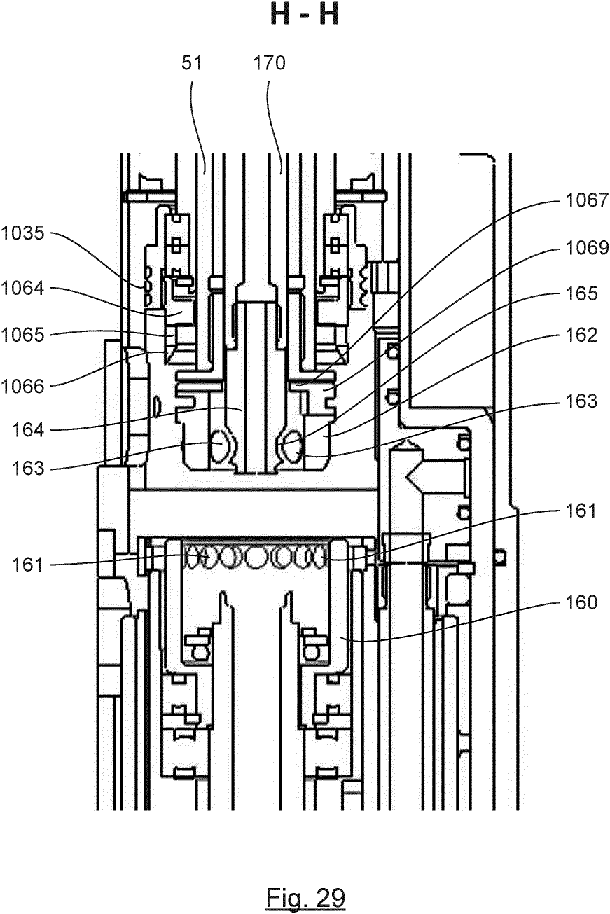

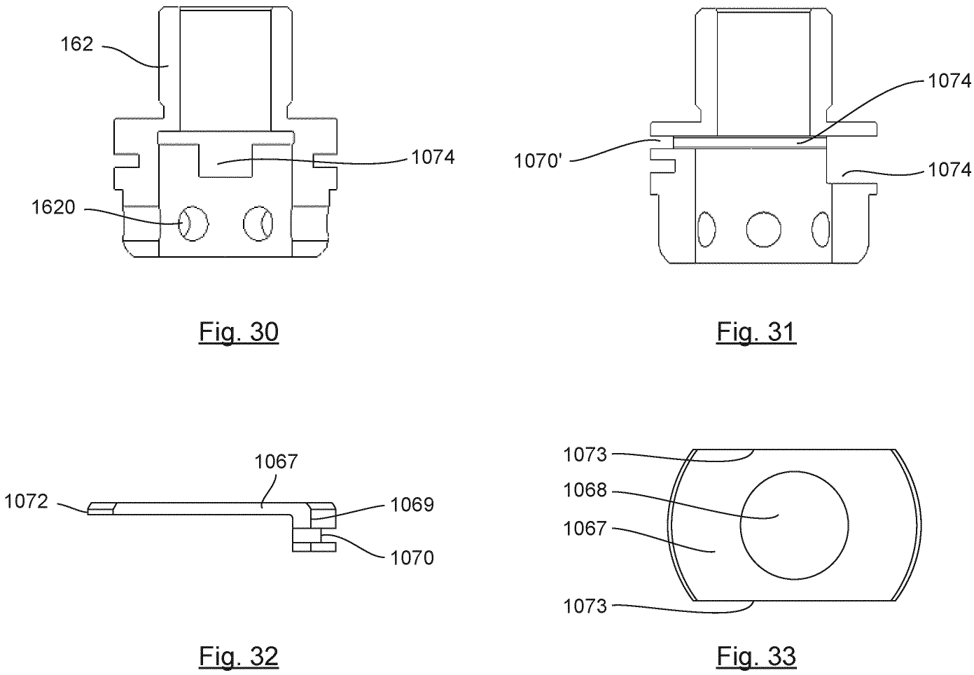

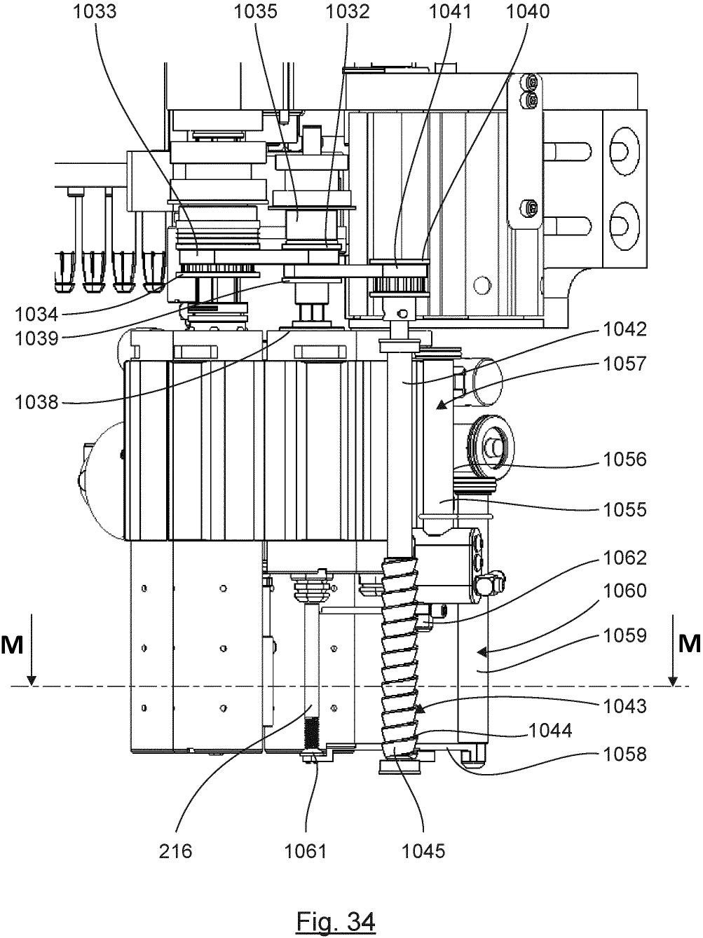

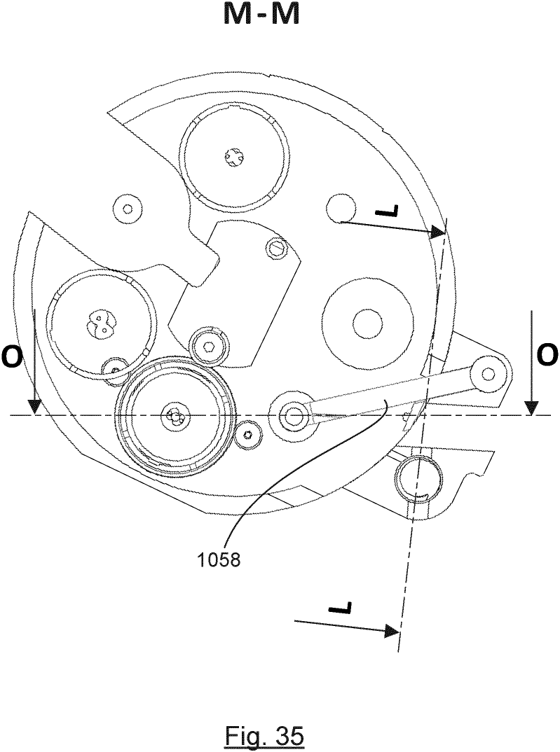

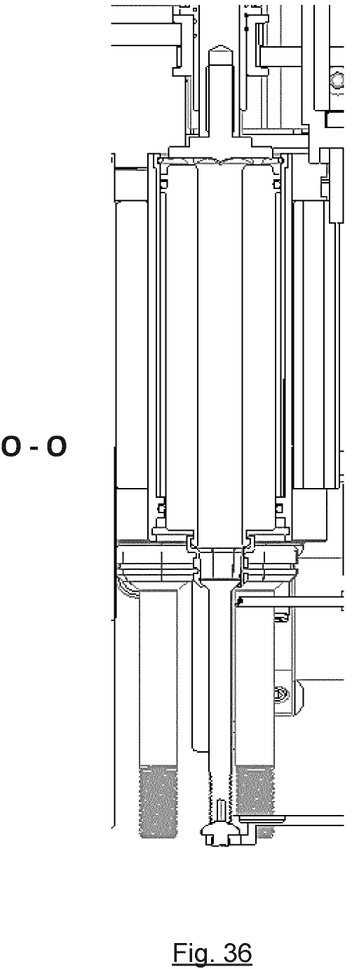

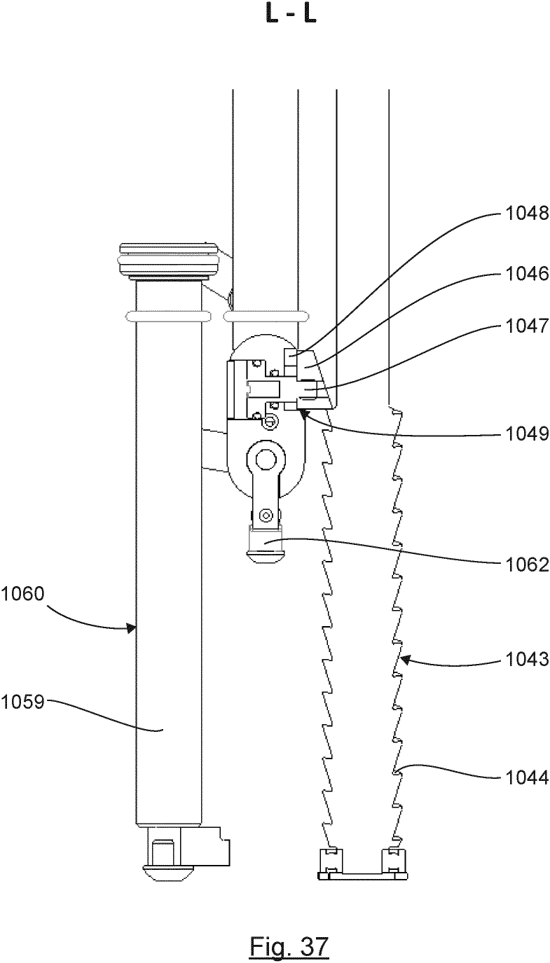

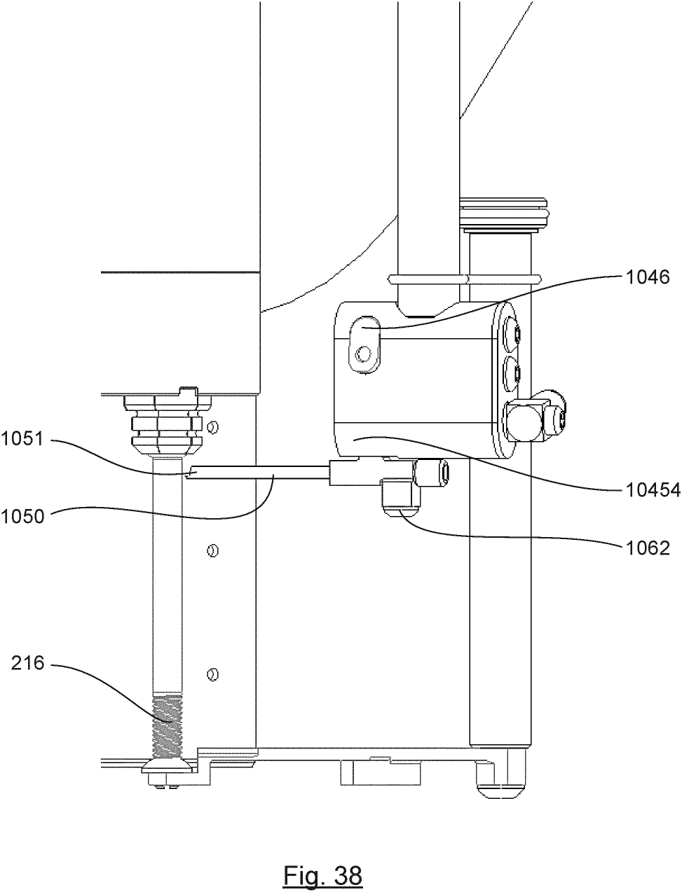

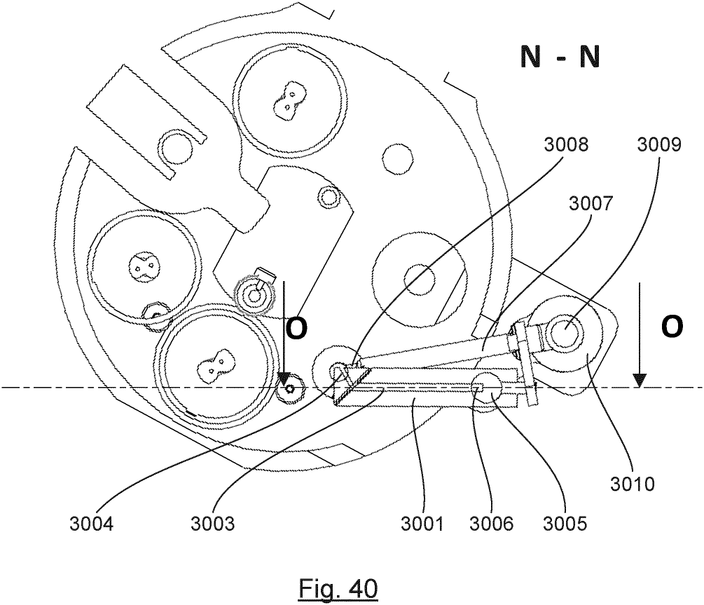

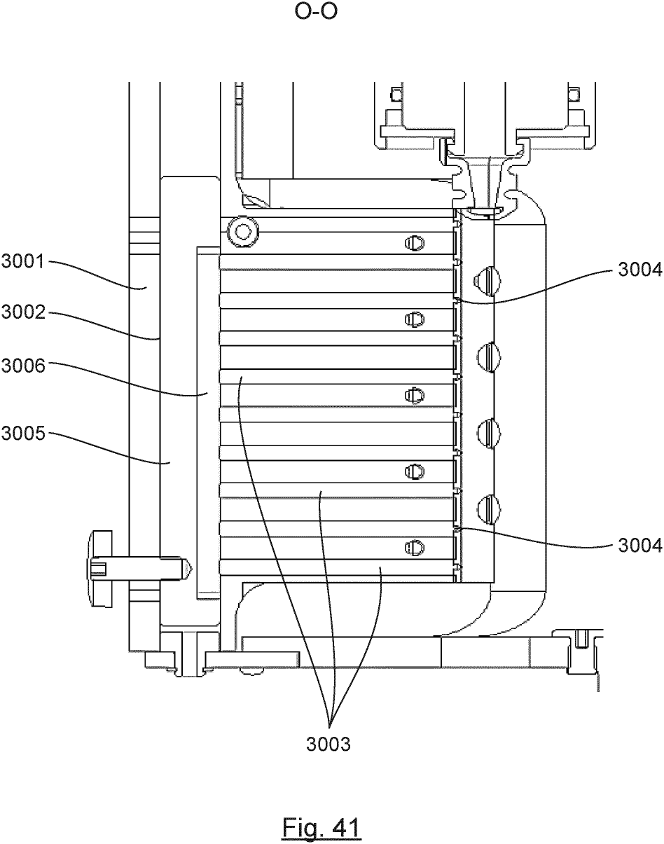

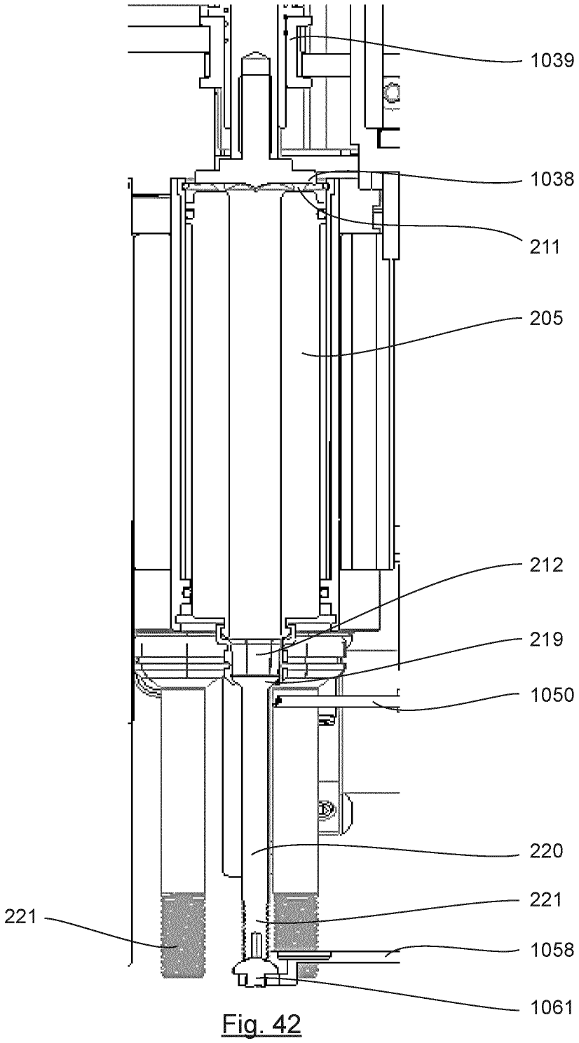

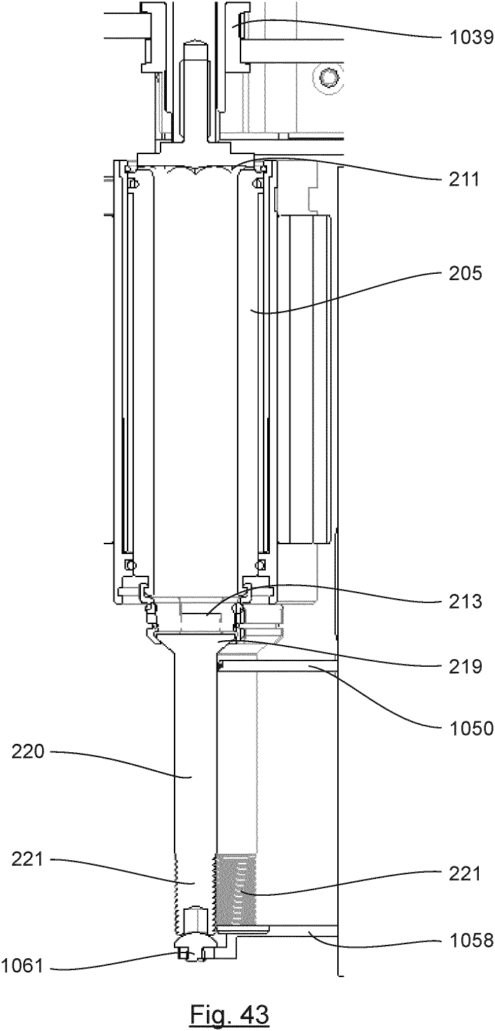

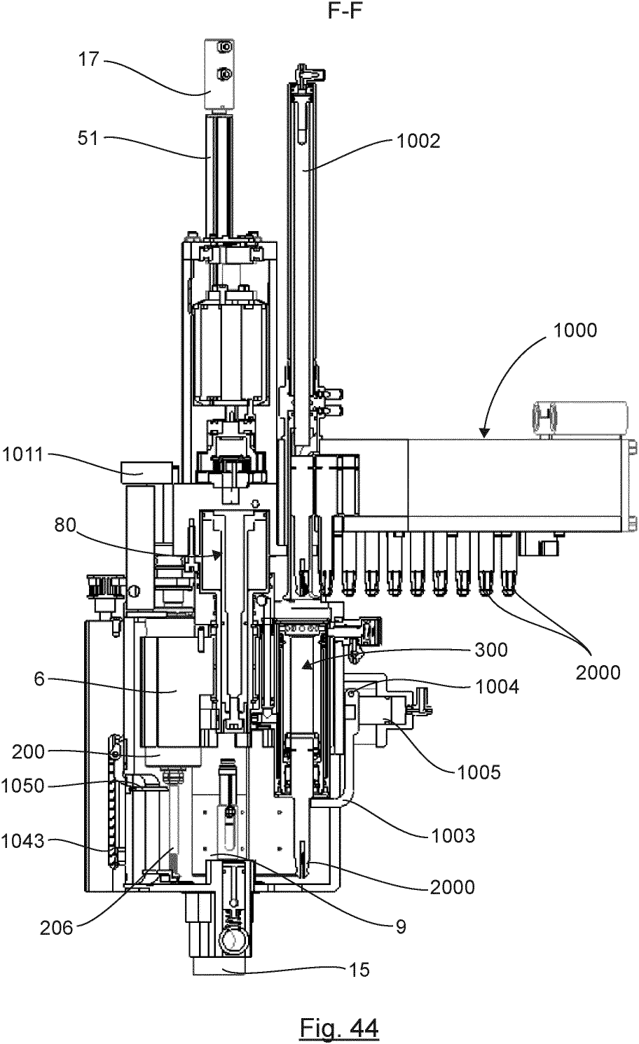

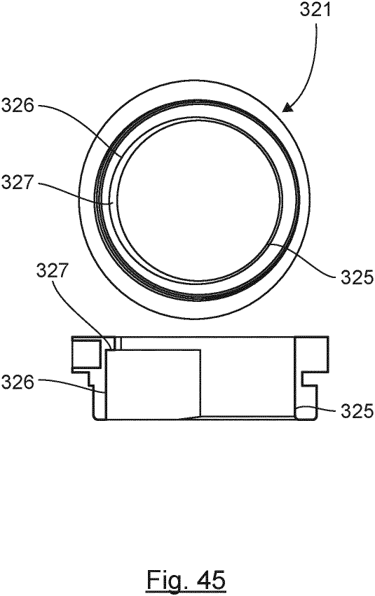

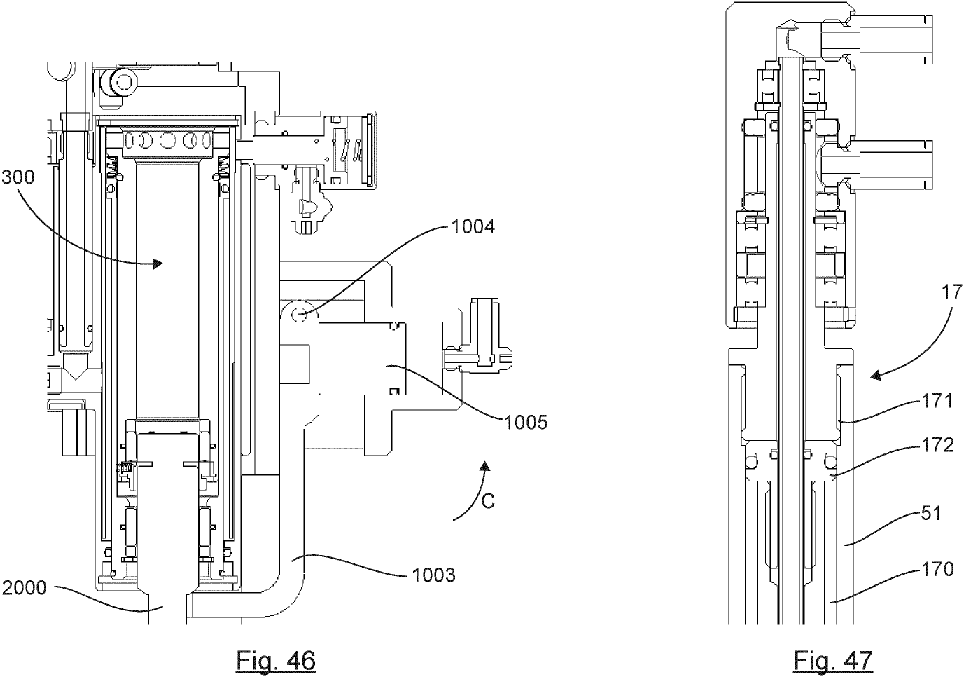

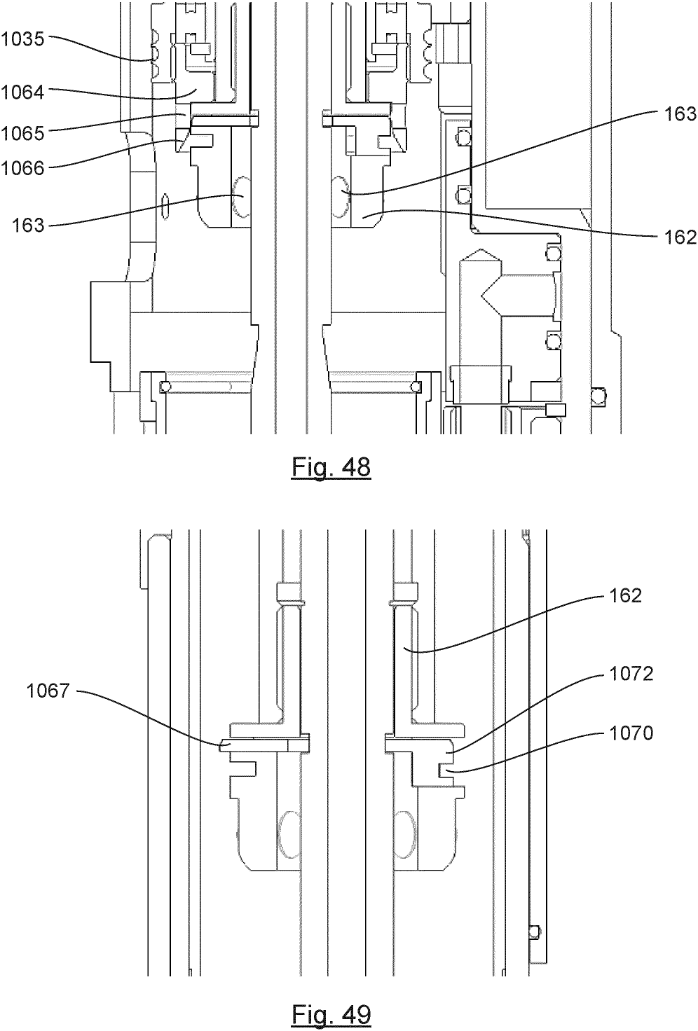

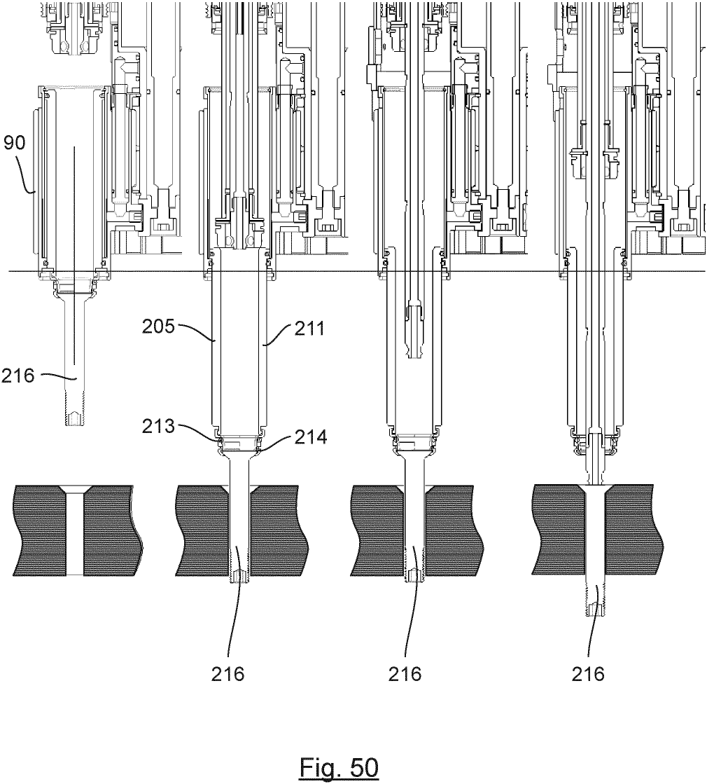

An example of a multi-task device according to the invention is described in relation to FIGS. 1 to 50.

As represented in these figures, such a multi-task device 1 comprises a rack 2.

This rack 2 is equipped with means 3 for securing to a motorised handling device (not represented) to which it is intended to be secured so as to be able to be moved relative to a structure that is to be worked (not represented).

These motorised handling means belong to the group comprising:
the robot arms;
the walking robots;
the digital grids.

In the illustrated example, these are means 3 for securing to a robot arm. These securing means comprise a plate 31 passed through by a plurality of holes 32 allowing the passage of securing bolts at the end of the robot arm. Other securing means might be implemented, such as for example quick securing means of the collar, clamp or cam system type···

In the case of digital grids, the fastening means will comprise for example bolts, collars or other means for securing to a cradle provided with rollers able to be guided into the rails of the digital grid.

### Means for Securing to a Structure That Is to Be Worked

The device comprises means 4 for securing to a structure that is to be worked.

These securing means can be of different types.

They can for example comprise suction cups 41 secured to the rack 2 which are capable of being connected to vacuum means such as for example a vacuum pump to improve the securing to the surface of the structure that is to be worked.

The suction cups can be secured in groups to supports, thus forming suction pads. Two suction pads are represented in FIGS. 1, 17 and 18, however this number could be greater than two.

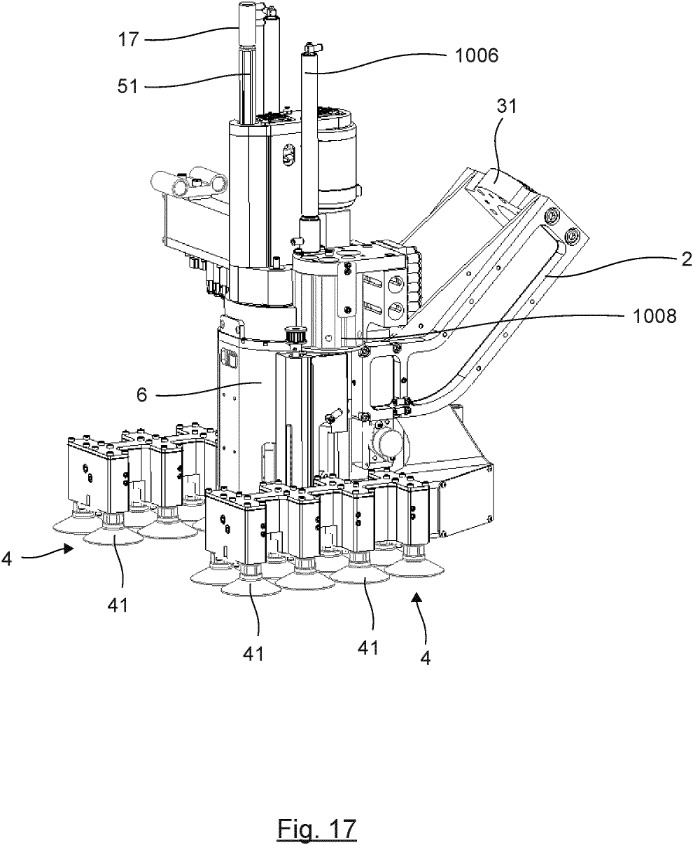

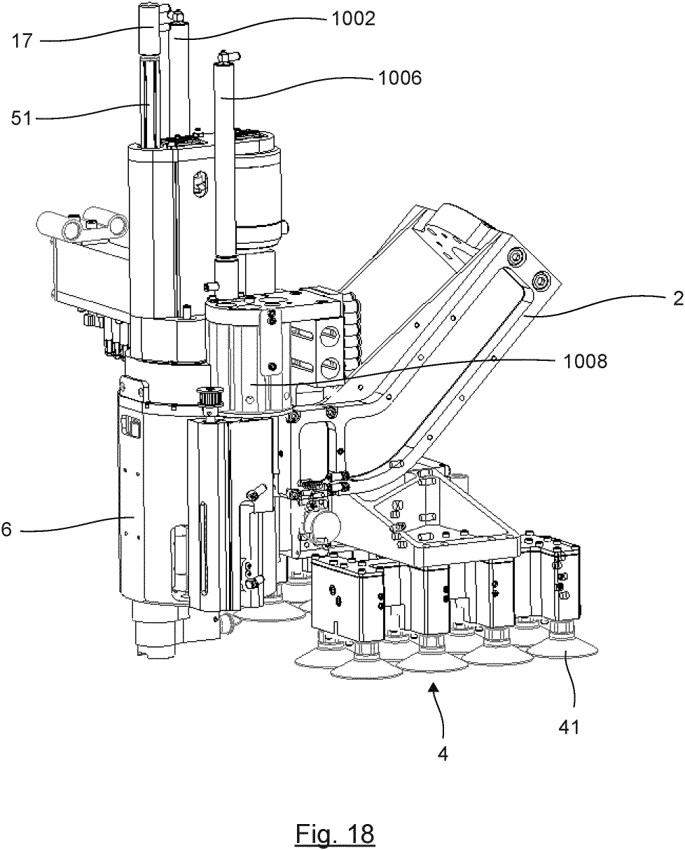

The suction cups can be offset on one side of the spindle 51 (which will be described in detail later) as shown in FIG. 18 or else distributed around the spindle 51 (see FIG. 17).

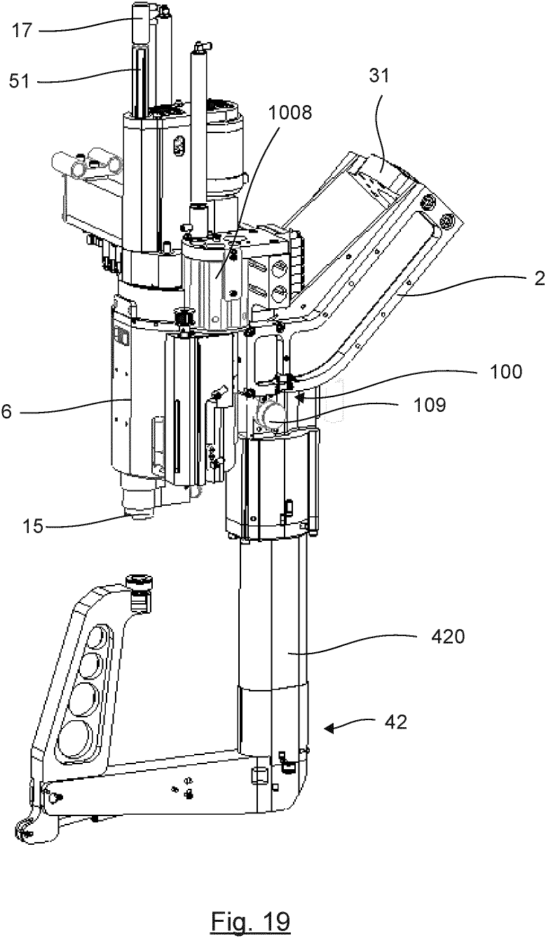

Alternatively, they may comprise a clamping C moreover known in the state of the art, such as for example that illustrated in FIG. 19.

The means for securing to a structure that is to be worked can be permanently secured to the rack. Alternatively, they can be secured to the rack via universal reversible fastening means 100.

### Universal Reversible Means for Fastening Means for Securing to a Structure That is to be Worked

The universal reversible fixing means 100 comprise a fastening plate 101.

In the case of the suction cups 41, the fastening plate 101 will be secured to a carrier structure carrying the suction cups.

In the case of the clamping C 42, the fastening plate 101 will be secured to the distal end of a bar 420 of the clamping C.

This fastening plate 101 has an essentially rectangular section in one plane and a section with two lateral grooves 102 in another plane orthogonal to the first plane.

These lateral grooves 102 extend all along the fastening plate 101 and comprise an inclined face 103 such that the thickness of the grooved portions of the fastening plate 101 tends to thicken from the ends of the plate to the inside thereof.

The universal reversible fastening means comprise a pair of jaws 104 of complementary shape to the grooved ends of the fastening plate 101.

These jaws 104 therefore each define a housing 105 capable of receiving the corresponding grooved end of the fastening plate 101. These housings 105 thus each have two opposite surfaces, one of which is inclined relative to the other at an angle substantially identical to the angle of inclination of the corresponding groove of the fastening plate.

Each jaw is secured to the cylinder 106 of a jack 109 whose rod 107 of the piston 108 passes through the jaw 104 and is secured to the rack.

The jaws 104 are movably mounted between at least:
an unsecuring position in which they are spaced apart to allow the insertion of the grooved ends of the fastening plate 101 in order to secure, to the rack, the means for fastening to a structure that is to be worked, and
a securing position in which they are brought together to enclose (grip) the grooved ends of the fastening plate 101 in order to secure, to the rack, the means for fastening to a structure that is to be worked.

During the passage thereof from their unsecuring position to their securing position, the inclined surfaces of the grooved ends of the fastening plate 101 gradually slide against the inclined surfaces of the corresponding jaws 104 to ensure a securing by wedge effect.

In order to fasten the desired securing means to the rack, the jacks 109 are actuated to place the jaws 104 in their unsecuring position.

The fastening plate 101 of the securing means is then inserted between the jaws 104.

The jacks 109 are then actuated to place the jaws 105 in their securing position in which they enclose the grooved ends of the fastening plate 101.

The unsecuring of the securing means is obtained by proceeding inversely.

### Functional Modules

The device is likely to on-board a plurality of functional modules which will be described in more detail later.

Each of these functional modules allows carrying out a particular task such as, for example, a drilling and/or countersinking operation, a rivet setting operation, an operation of setting a temporary fastening (for example a clip), a removal (or coating) operation on a fastening element (a rivet or a screw) of a bead of sealing mastic. Other functions could be considered such as screwing.

### Drilling And/or Countersinking Module

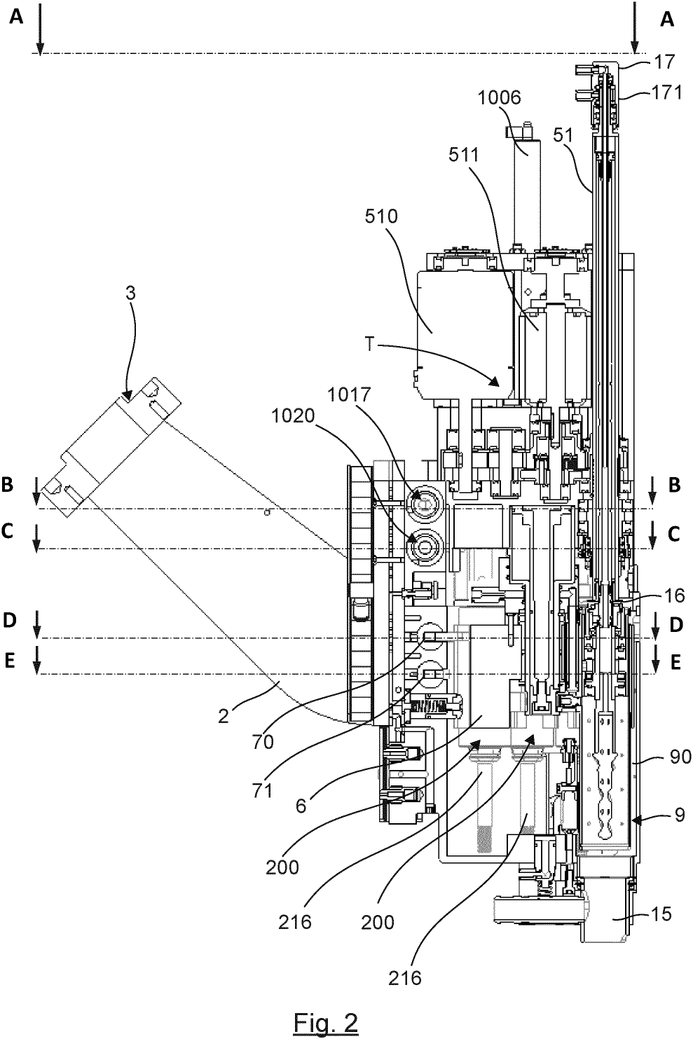

The functional module 9 illustrated in alignment with the spindle 51 in FIG. 2 is a drilling module.

The drilling module comprises a sheath 90.

This sheath 90 has a tubular shape and a generally annular section.

The sheath 90 comprises a lateral finger 900 forming a protrusion on the lateral wall thereof.

The sheath 90 comprises a lateral groove 901 which is formed in a diametrically opposite manner and offset along the longitudinal axis of the sheath relative to the finger 900.

This drilling module comprises an output shaft 91 (i.e. mobile member) at the end of which a cutting tool such as a drill bit 92 can be secured (possibly stepped to allow carrying out a countersink) by fastening means 93 known per se. The cutting tool could for example be a simple drill bit for making simple bores, a stepped drill bit, a countersink drill bit for making countersunk bores, a milling tool for countersinking previously made bores.

The output shaft 91 is mounted movable in rotation in a bearing 94 itself slidably mounted along the sheath 90 by means of a bushing 95.

The finger 900 of the sheath 90 of the drilling module houses a chamber 902 in which a piston 903 of a jack 904 is slidably mounted. The end 905 of the piston 903 is likely to be housed in a housing of complementary shape 950 formed at this effect in the bushing 95.

The finger 900 is extended by a supply conduit 906 of the jack 904 likely to be placed communicated with a pressurised air intake conduit 907 formed in the device, with which it is in communication when it is located at the device workstation.

Elastic return means (not represented) tend to return the piston 903 into a position in which the end 905 thereof is housed in the corresponding housing 950 of the bushing 95 so as to block the latter in translation inside the sheath 90 and to consequently prevent the bushing 95, the bearing 94, the output shaft 91 and the tool 92 which it carries from leaving the sheath 90 as long as the functional module is not coupled to the spindle 51.

The end 905 and the corresponding jack 904 constitute means for blocking in translation a functional assembly of functional module inside the sheath thereof. A functional assembly comprises all components of a functional module mounted free in translation in the sheath thereof.

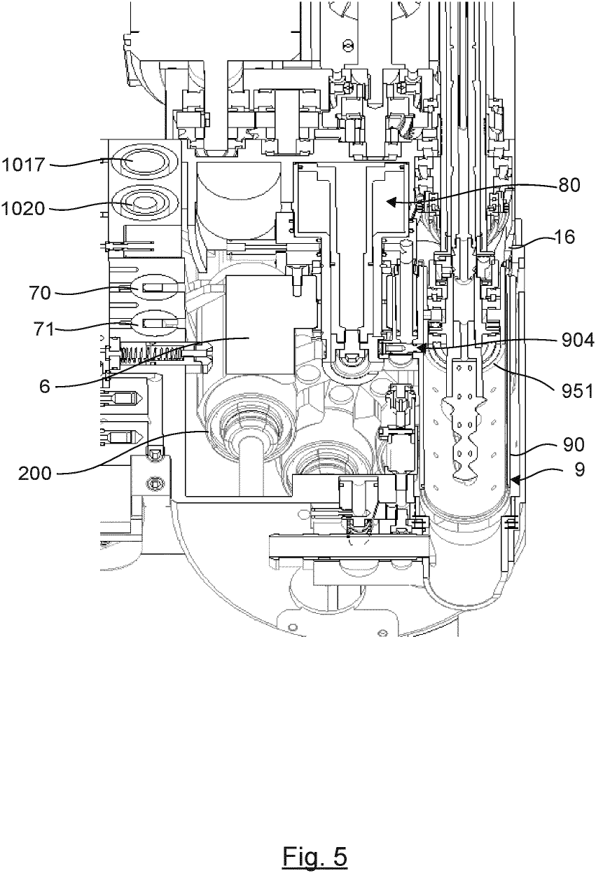

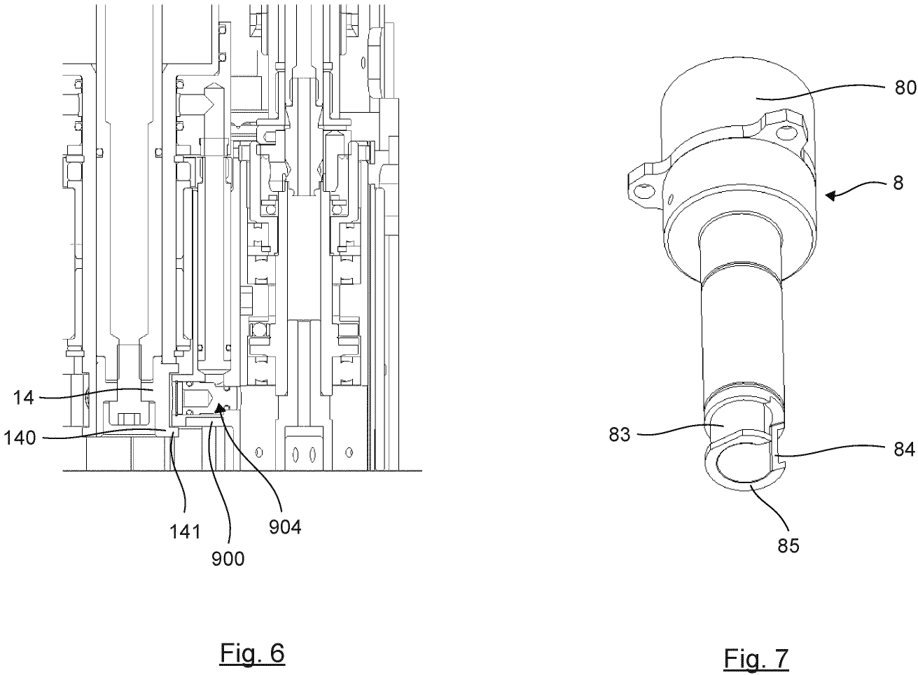

Alternatively, the elastic return means could be implemented so that the end 905 protrudes inside the sheath 90 to form a stop for the bushing 95 preventing the functional assembly from sliding inside the sheath beyond its position illustrated in FIGS. 5 or 6.

Furthermore, (in the two variants of operation of the jack 904 and the end 905), the sleeve houses, at each of the ends thereof, a stop segment (not represented) each forming an end stop for the functional assembly. Thus, a functional drilling module assembly can slide inside the sheath between these stop segments as long as the end 905 does not protrude into the housing 950 or directly into the sheath.

The drilling module comprises a bell 160 secured to the output shaft 91 and linked, for the purposes of transmitting movement, thereto. This bell comprises radial holes 161.

A screwing module could be made with a structure substantially identical to that of the drilling module. In this case, the fastening means 93 of a cutting tool would be replaced by means for securing a socket or a screwing imprint to the output shaft. This could suppose that the feed of the spindle 51 is driven so that the feed per revolution of the spindle is substantially equal to the pitch of the screw so that the socket or the screwing imprint advances synchronously with the screw. A telescopy could further be necessary to allow insertion.

### Rivet Support Module

The rivet support module 200 allows holding the rivet and comprises, as the drilling module, a sheath 90.

This sheath 90 has a tubular shape and a generally annular section.

The sheath 90 comprises a lateral finger 900 forming a protrusion on the lateral wall thereof.

The sheath 90 comprises a lateral groove 901 which is housed in a diametrically opposite manner and offset along the longitudinal axis of the sheath relative to the finger 900.

The sleeve houses a tubular element 201 which has, at one of the ends thereof, a shoulder 202 designed to bear against a shoulder 203 of complementary shape formed at one end of the sheath 90.

The opposite end thereof being in the vicinity of a shoulder 204 formed in the lower portion of the sheath 90, without however being in contact with this shoulder to allow pressurised air to pass between the outer surface of the tubular element 201 and the inner surface of the sheath 90, as will emerge more clearly later.

The tubular element 201, which constitutes a chamber, houses a piston 205 which is mounted movable in translation therein.

The piston 205 comprises, at one end, a flange 206 provided with a circumferential groove 207 housing an O-ring 208. This O-ring 208 ensures the sealing between the piston 205 and the tubular element 201.

The shoulder 204 of the sheath 90 also comprises an inner circumferential groove 209 housing an O-ring 210 ensuring the sealing between the piston 205 and the sheath 90.

The lateral finger 900 of the sheath 90 houses an air conduit which extends along the sheath and which is likely to be communicated with a pressurised air inlet conduit 907 formed in the device, with which it is in communication when he is at the workstation of the device.

The end of the piston 205 located on the inner side of the shoulder 204 of the sheath 90 comprises a half-dog 211 whose function will be explained later.

The other end of the piston 205 carries a split ring 212 which constitutes means for holding the rivet at the end of the piston.

This split ring 212 has a conical inner borehole 213 whose diameter tightens starting from the inside of the piston 205 to the outside thereof. This conical portion 213 opens into an inner groove 214 of complementary shape to that of the end of the head 219 of a rivet 216. This groove 214 also opens into a conical inner portion 215 whose diameter narrows in the direction of the outside of split ring 212.

This ring 212 has a plurality of longitudinal grooves (not represented) to allow it to be deformed during the insertion and extraction of a rivet, as will be described in more detail later.

The split ring 212 comprises at least one outer peripheral groove 217 housing an elastic return element such as an O-ring or a spring (not represented) ensuring a return means function tending, as will be explained in more detail later, to return the ring from a release state in which its inner diameter is enlarged, to a holding state in which its inner diameter is tightened.

The tubular element forms, with the split ring, a fastening element support element.

The piston is passed through by an inner borehole allowing the passage of a rivet.

Several rivet support modules could be provided with inner borehole pistons of different diameter and different sized split ring to allow holding rivet of different sizes.

The piston 205 is provided to be driven in rotation and/or in translation. It thus constitutes a mobile member.

The piston 205 is movable in translation in the tubular element 201 between a first extreme position in which the shoulder 207 thereof abuts against a circlip 218 provided for this purpose at the end of the tubular element 201 located opposite to that located close in the vicinity of the shoulder 204 of the sheath, and a second extreme position in which the shoulder 207 thereof abuts against the shoulder 204 of the sheath.

A module of the type of that of the rivet support could be implemented to support another type of fastening element such as for example a screw. In this case, the split ring would of course have a shape adapted to that of the head of a screw rather than that of the head of a rivet.

### Temporary Fastening Support Module

The temporary fastening support module 300 comprises a sheath 90.

This sheath 90 has a tubular shape and a generally annular section.

The sheath 90 comprises a lateral finger 900 forming a protrusion on the lateral wall thereof.

The sheath 90 comprises a lateral groove 901 which is formed in a diametrically opposite manner and offset along the longitudinal axis of the sheath relative to the finger 900.

This finger 900 houses an air conduit 906 which extends along the sheath and which is likely to be communicated with a pressurised air intake conduit 907 formed in the device, with which it is in communication when it is at the workstation of the device.

The sheath 90 houses a tubular element 301. This tubular element 301 has a shoulder 302, at one of the ends thereof, bearing against a shoulder 303 formed inside the sheath 90 at one of the ends thereof.

The tubular element 301 has a second shoulder 304 located in the vicinity of the air conduit formed in the finger. This shoulder delimits a smaller diameter portion of the tubular element.

The tubular element 301 has another end which extends in the vicinity of a second shoulder 305 formed inside the sheath at the other end of the latter. However, a space is formed between the two to allow the passage of air.

The tubular element 301 delimits a chamber housing a piston 306. This piston 306 comprises, at one of the ends thereof, a shoulder 307 having a circumferential groove 308 housing an O-ring 309 ensuring the sealing between the piston 306 and the tubular element 301.

The shoulder 305 of the sheath 90 comprises an inner circumferential groove 310 housing an O-ring 311 ensuring the sealing between the sheath 90 and the piston 306.

The piston 306 is mounted movable in translation inside the tubular element 301 and the sheath 90.

The piston 306 comprises a first borehole 312 housing a drive tube 313 (mobile member) mounted movable in translation and in rotation inside the latter.

This drive tube 313 comprises, at one of the ends thereof, a flange 314 defining a bell 160 passed through by radial holes 161.

Elastic return means 315, such as for example elastic washers or a spring, are interposed between the flange 314 of the drive tube 313 and the shoulder 307 of the piston 306. These return means tend to move this flange and this shoulder away from each other.

The drive tube and the piston are movable and connected in translation in the module between at least:
a retracted position in which they extend inside said module, and
a deployed position in which at least one of these elements extends at least partially outside the module, i.e. the sheath.

The bell 160 of the drive tube 313 communicates with a first cylindrical borehole 316, which communicates with a second borehole 317.

This second borehole houses a first freewheel 318.

The second borehole 317 communicates with a third borehole 320. The third borehole 320 houses a locking element 321 which is held therein by means of a circlip 322 housed, on the one hand, in a groove 323 provided for this purpose in the tube of drive 313 and, on the other hand, in a groove 324 provided for this purpose in the locking element 321.

The module comprises means for holding a temporary fastening in the module. These means for holding the locking element.

The locking element 321 is in the form of a ring passed through which a borehole 325 passes, having an eccentric portion 326 defining a protruding locking lug 327. The locking element 321 comprises a peripheral housing 328 housing return means (not represented), such as a compression spring, interposed between the locking element 321 and the drive tube 313. The locking element 321 is movable inside the third borehole 320 laterally in a direction perpendicular to the longitudinal axis of the drive tube 313 between at least:
one rest position in which the end of the locking lug 327 is away from the longitudinal axis of the drive tube 313 (it is retracted), and
a locking position in which the end of the locking lug 327 is brought closer to the longitudinal axis of the drive tube 313 (it is deployed inside the module).

The compression spring tends to return the locking element 321 to its locking position.

The first borehole 312 of the piston 306 communicates with a second borehole 329 comprising a conical portion 331 narrowing towards a cylindrical portion 332.

The second borehole 329 of the piston 306 communicates with a third through borehole 333.

This third borehole 333 houses a second freewheel 334 held in place by means of a circlip 335. An O-ring 336 ensures rotational drive between the third borehole 333 and the second freewheel 334.

As will become clearer later, the first and second freewheels have antagonistic drive capabilities.

### Single Drive and Control Assembly

The device comprises a single drive and control assembly 5 of the functional modules.

This drive and control assembly 5 comprises a single drive spindle 51 called main spindle. This spindle is mounted movable in rotation and in translation along the same axis, i.e. along the longitudinal axis. The spindle is thus mounted movable in translation between a retracted position and a deployed position in the direction of the workstation.

This assembly 5 also comprises drive means 52 capable of driving the movement of the drive spindle 51.

In this embodiment, these drive means comprise a feed motor 510 and a rotation motor 511. They also comprise a gearing system T allowing driving the movement of the spindle 51 via the feed and/or rotation motors according to the translational and/or rotational movements along the axis thereof.

This gearing system is of the type comprising a translational drive yoke 512 and a rotational drive ring 513.

The rotation drive ring 513 has an inner borehole whose inner periphery comprises cotters 5131 of complementary shape to grooves 510 formed along the spindle 51 along the longitudinal axis thereof. In this manner, the spindle 51 and rotational drive ring 513 are connected in rotation along the axis of the spindle, but free in translation along this axis.

The translational drive yoke 512 has a threaded inner borehole 5121 of complementary shape to a threaded portion 511 formed along the spindle so that they are connected by a helical connection.

This type of gearing system is known per se and is not described in more detail herein.

An example of gearing system of this type is described in particular in patent EP-B1-2 754 531 which has the advantage of making the feed speed of the spindle only dependent on the rotational frequency of the feed motor.

Other gearing system architectures producing the same effect could be considered.

This type of gearing system allows laterally offsetting the motor(s) relative to the spindle. The motor(s) are then located next to the spindle rather than in the extension thereof. This improves the compactness of the device, allows reducing the distance to the centre and thus performing tasks in the vicinity of a wall, and also to reduce the overhang. In the illustrated example, the axes of the motors are essentially parallel to the axis of the spindle. In variants, one or the other of these motors, or even both, might have an axis inclined relative to that of the spindle, in particular orthogonal.

As will be described in more detail below, the device comprises coupling gear for making the drive spindle and at least one mobile member of a functional module which is coupled to the pin alternately secured to each other, for the purposes of transmitting movement.

The single drive and control assembly 5 conventionally comprises a controller 53 comprising all the components necessary for driving the operation of the motors and all the actuators and other sensors of the device. Such a controller comprises in particular all memories, program(s) and processor(s) necessary for driving the device and for carrying out the different tasks. It also includes communication means (transmitter-receiver) able to allow it to receive and transmit data in a wired or wireless manner. It can also integrate the components required to power the motors (of the inverter type). It may also comprise means for entering instructions (keyboard, microphone, mouse, touchscreen or other), a display screen, means for emitting sound signals... Such a controller may be, in whole or in part, secured to the rack or placed at a distance.

The single drive and control assembly 5 comprises means for measuring at least one physical parameter representative of at least one characteristic of operation of the functional modules. These parameters can in particular be indicative of at least one following magnitude:
a couple on at least one mobile member of the module coupled to the spindle;
an axial force on at least one mobile member of the module coupled to the spindle;
an angular position of at least one mobile member of the module coupled to the spindle;
an axial position of at least one mobile member of the module coupled to the spindle.

In variants, the control means comprise means 530 for measuring the electrical intensity consumed by the motor(s) (current sensor) and for determining, depending on the measured electrical intensity, a torque and/or an axial force on the spindle and therefore on one or more output members of a functional module coupled to the spindle. This type of means for measuring and determining forces or torques depending on the current consumed by a motor are known per se and not described in detail.

In variants, the control means comprise one or more angle sensors 531 integrated into one or more of the motor(s). An angle sensor is a sensor for measuring the angular position of the rotor of a motor. The control means then comprising means for determining, depending on the angular position of said measured rotor, the angular position and/or the axial position of said at least one mobile member of a functional module coupled to the spindle. This type of means for measuring and determining position depending on the angular position of the rotor of a motor are known per se and not described in detail.

In variants, the measurement means comprising at least one torque and/or force and/or position sensor 532 integrated in the gearing system T and capable of allowing the determination of a torque and/or an axial force on the spindle and/or of an angular and/or axial position of the spindle, and therefore by deduction of a torque and/or of an axial force and/or of an angular position and/or of an axial position of the at least one mobile member of a module coupled to the spindle. This type of means for measuring and determining forces or torques are known per se and not described in detail.

Several of the different measurement means mentioned above can of course be used in combination.

### Means for Carrying Modules: Carousel

A device according to the invention comprises means for carrying a plurality of functional modules. These carrying means allow on-boarding and moving several functional modules. In the illustrated embodiment, the number of modules likely to be on-board is equal to 7, but could be alternatively different (lower or higher). This number can be even or odd.

In this embodiment, these carrying means comprise a carousel called main carousel 6. The main carousel 6 comprises, like a revolver barrel, a plurality of cells 61 each allowing housing a functional module.

Each cell 61 constitutes a borehole opening on both sides and extending parallel to the axis of rotation of the carousel. The cells 61 are preferably essentially evenly distributed about the axis of the carousel.

### Functional Stations

The device comprises several functional stations.

The carousel not only allows on-boarding several functional modules, it also allows moving them from one station to another. It is, to this end, mounted movable in rotation about the axis thereof which extends essentially parallel to that of the main spindle as will be described in more detail later.

In this embodiment, the functional stations are as follows:
a functional module loading/unloading station P1;
a temporary fastening loading station P2 (in this embodiment, the stations P1 and P2 are combined to form a multifunction station, but could constitute two separate stations);
a rivet loading station P3;
a rivet coating station P4;
a workstation P5 in the extension of the single spindle 51 and which can be carried out, according to the module located at this station, operations of:
   -drilling and/or countersinking;
   rivet setting;
   temporary fastening setting.

### Functional Module Loading/Unloading Station

The station P1 for loading/unloading functional modules allows inserting functional modules one by one into cells of the carousel and extracting them therefrom.

At this station, the device comprises a jack 13 whose piston 11, which carries a lug 10, is movable in translation in a chamber 12 along an axis orthogonal to the axis of a cell of the carousel brought to the loading /unloading station.

The function of this jack will be described later.

### Temporary Fastening Loading Station

The device comprises a temporary fastening loading station P2 for inserting a temporary fastening into a temporary fastening support module brought to this station by the carousel.

In this embodiment, the temporary fastening loading station is located at the functional module loading/unloading station. These two stations thus constitute a single dual function functional station.

The temporary fastening loading station could, however, be located at another location.

This station P2 comprises a device for supplying a temporary fastening 1000. This device comprises a bandolier-type actuator allowing moving temporary fastenings 1001 in translation until they are placed in the axis of the temporary fastening support module brought to the temporary fastening loading station P2.

This station P2 also comprises a loading jack 1002. This jack 1002 is placed in the axis of a temporary fastening support module 300 brought by the carousel 6 to the temporary fastening loading station.

This jack 1002 is disposed upstream of a temporary fastening 1001 placed by the bandolier 1000 in the axis of the temporary fastening loading station P2 to allow acting thereon in order to insert it into the support module 300, as will be explained in more detail later.

The temporary fastening loading station P2 further comprises a temporary fastening holding device in the temporary fastening support module 300 when it is inserted into this module. This holding device comprises an essentially L-shaped fork 1003 whose end comprises two fingers which are spaced apart to form a space for receiving a temporary fastening.

This fork 1003 is placed at the output of a temporary fastening support module 300 placed at the temporary fastening loading station P2 and is mounted movable in rotation about an axis 1004 between:
a holding position in which the end thereof provided with fingers extends essentially perpendicular to the temporary fastening support module and forms an end stop against which a temporary fastening can bear when it is inserted into a temporary fastening support module, and
a release position in which the fork is pivoted about the axis thereof according to arrow C such that the end thereof provided with fingers is disengaged from the module to allow it to be driven in rotation by the carousel.

The movement of the fork 1003 is ensured by means of a jack 1005.

### Rivet Loading Station

The device comprises a rivet loading station P3.

This rivet loading station P3 comprises a loading jack 1006. This jack 1006 is placed in the axis of a rivet support module brought by the carousel to the rivet loading station.

This station P3 comprises a device for receiving and transferring rivets from a rivet supply (or delivery) zone 1007 (or other fastening element such as screws or other) to a rivet distribution or rivet receiving zone such as for example herein a rivet support module 200 located at the rivet loading station P3.

The reception and transfer device comprises a carousel called secondary carousel 1008. The carousel constitutes a support element. This carousel 1008 comprises, like a revolver barrel, a plurality of cells 1009 each allowing housing a rivet.

Each cell 1009 constitutes a borehole opening on both side and extending parallel to the axis of rotation of the carousel 1008. The cells 1009 are preferably essentially evenly distributed about the axis of the carousel 1008.

In this embodiment, the number of cells is equal to six. It can of course be greater or less than 6.

In particular, the carousel and the cells thereof form fastening element receiving means. The carousel and the drive means thereof allow moving fastening elements from a supply zone to a distribution zone.

Each cell 1009 has a different diameter so that each cell allows receiving rivets 216 of different sizes.

Each cell 1009 comprises a receiving orifice 1090 and a dispensing orifice 1091 of the fastening element. The receiving orifice 1090 allows inserting a fastening element into a cell. The dispensing orifice allows evacuating a fastening element outside the cell.

The device comprises means for holding a fastening element inserted into a cell. These holding means prevent the extraction, through the receiving orifice, of a fastening element located in a cell.

In this embodiment, the holding means comprise a deformable element 1092 provided with a point forming a spear 1093 located in each cell. The point of each spear is shaped to allow inserting a fastening element into the cell through the receiving orifice thereof and preventing the extraction of the fastening element through the receiving orifice of the cell. Thus, the point of each spear is oriented towards the receiving hole of the corresponding cell.

The carousel 1008 is mounted movable in rotation along an axis which is essentially parallel to the axis of the main spindle 51, between a support plate 1011 and a rivet holding plate 1012. The holding plate constitutes a means for holding the fastening elements in the cells.

The support plate 1011 is secured to the rack and fixed relative thereto. It is passed through by as many holes 1013 as the carousel 1008 comprises cells 1009. Each hole has a different diameter corresponding to that of a cell. The support plate 1011 carries a shaft 1014 about which the carousel 1008 is mounted movable in rotation.

One of the holes 1013 of the support plate 1011 is located in the axis of the loading jack 1006.

The holding plate 1012 comprises, in the axis of each hole 1013 of the support plate 1011, air exhaust holes 1015. It is however passed through by a dispensing opening 1080, and not by air exhaust holes 1015, in the axis of the jack 1006. The diameter of the dispensing opening 1080 allows the passage of the largest rivet likely to be on-board in the secondary carousel.

The carousel 1008 comprises, along the outer peripheral contour thereof, longitudinal indentations 1016 which extend essentially parallel to the axis of the carousel 1008. These indentations form drive teeth as will emerge more clearly subsequently.

The device comprises means for driving in rotation the carousel about the shaft.

These rotational drive means comprise:
a first jack 1017 comprising a piston 1018 which is movable in translation in a chamber 1019;
a second jack 1020 comprising a piston 1021 which is movable in translation inside a chamber 1022.

The piston 1018 of the first jack 1017 carries a pawl 1023 which is mounted movable in rotation relative to the piston about an axis 1024 which is essentially parallel to the axis of rotation of the carousel 1008.

The pawl 1023 comprises a support surface 1025 provided to bear against a stop 1026 of the piston 1018 defining the extreme drive position.

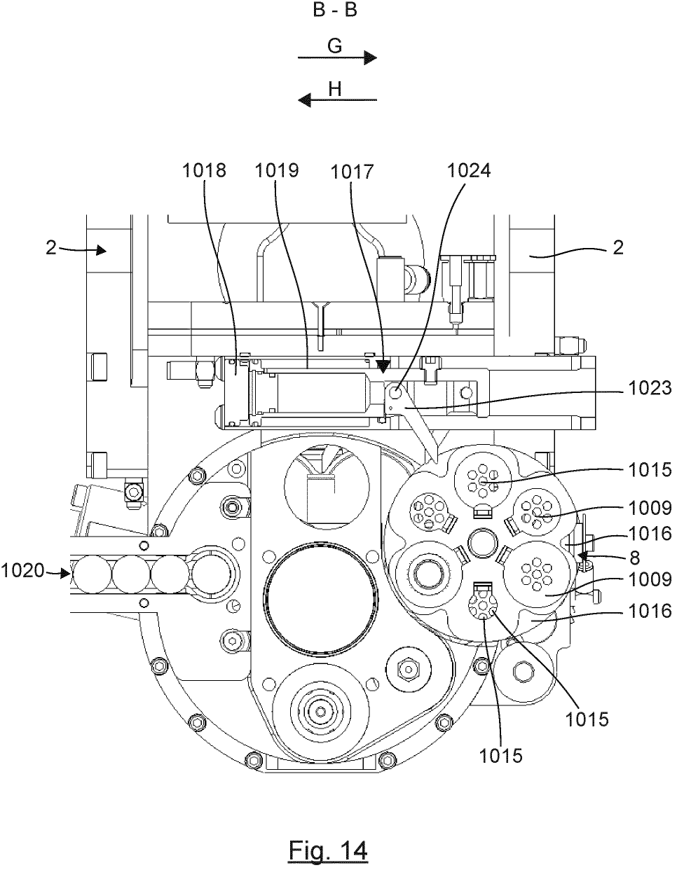

The pawl 1023 is movable between two extreme positions, namely:
a deployed position in which the bearing surface 1025 thereof bears against the stop 1026 of the piston 1018 so that the end thereof is separated from the piston and at least partially housed in an indentation 1016 of the carousel (see FIG. 14), and
a retracted position in which the bearing surface 1025 thereof is not bearing against the stop 1026 of the piston 1018 so that the end thereof is close to the piston 1018 and clear of any indentation 1016 of the carousel.

Return means (not represented), such as for example a spring or other, can possibly be implemented to act on the pawl 1023 to tend to return it to its deployed position.

The piston 1018 is movable between two extreme positions, namely:
a starting position in which it is in abutment on the left side in FIG. 14 (insofar as the device can take any orientation in space, the indication of the left side is purely illustrative with reference to FIG. 14 for ease of understanding), and
an end position in which it is in abutment on the right side in FIG. 14 and the pawl 1023 is in the deployed position between two indentations 1016.

In the configuration illustrated in FIG. 14, the piston 1018 is in its start position and the pawl 1023 is in its deployed position.

The device comprises a blocking pin 8 movably mounted between a blocking position in which it is brought into abutment against the carousel 1008 between two consecutive indentations 1016 to prevent rotation of the carousel about the axis thereof, and a release position in which it is released from the carousel to enable its rotation. This blocking pin 8 is secured to the support plate 1011 by means of a leaf spring 1027 which tends to hold it in its blocking position. It constitutes a means for blocking and indexing the carousel 1008 in positions in which a cell 1009 of the carousel 1008 is in alignment with the loading jack 1006, i.e. at the distribution zone. Preferably, at least one other cell is then located in a supply zone.

In order to drive in rotation the carousel 1008 clockwise, pressurised air is injected into the chamber 1019 so as to move the piston 1018 according to the arrow G in its end position. During this movement, the bearing surface 1025 of the pawl 1023 abuts against the stop 1026 of the piston 1018 so that the pawl 1023 is blocked in rotation in the clockwise direction. The carousel 1008 is thus driven in rotation in the clockwise direction until the piston 1018 is in abutment in its end position. A new cell 1009 of the carousel 1008 is then in alignment with the loading jack 1006. During the movement of the carousel 1008, the blocking pin 8 slides against the peripheral surface of the carousel 1008 and is gradually moved from its blocking position in its unblocking position against the effect of the leaf spring 1027 then again in its blocking position under the effect of the leaf spring 1027 so that the carousel 1008 is held stationary.

The jack 1017 is actuated according to arrow H to return into its start position. During this movement, the pawl 1023 slides against the peripheral surface of the carousel 1008 and gradually passes from its deployed position to its retracted position then to its deployed position by rotating about the axis thereof.

The carousel 1008 can again be driven in rotation clockwise by repeating this process.

The piston 1021 of the second jack 1020 carries a pawl 1028 which is mounted movable in rotation relative to the piston 1021 about an axis 1029 essentially parallel to the axis of rotation of the carousel 1008.

The pawl 1028 comprises a support surface 1030 provided to bear against a stop 1031 of the piston 1021 defining the extreme drive position.

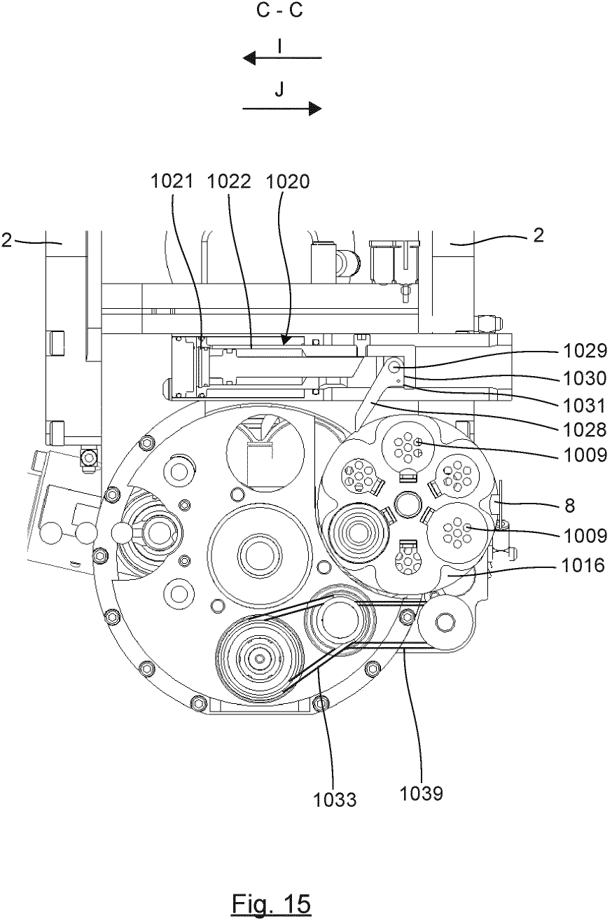

The pawl 1028 is movable between two extreme positions, namely:
a deployed position in which the bearing surface 1030 thereof bears against the stop 1031 of the piston 1021 so that the end thereof is separated from the piston 1021 and at least partially housed in an indentation 1016 of the carousel 1008 (see FIG. 15), and
a retracted position in which the support surface 1030 thereof is not bearing against the stop 1031 of the piston 1021 so that the end thereof is close to the piston 1021 and clear of any indentation 1016 of the carousel 1008.

Return means (not represented), such as for example a spring or other, may possibly be implemented to act on the pawl 1028 to tend to return it to its deployed position.

The piston 1021 is movable between two extreme positions, namely:
a starting position in which it is in abutment on the right side in FIG. 15 (insofar as the device can take any orientation in space, the indication of the right side is purely illustrative with reference to FIG. 15 for ease of understanding), and
an end position in which it is in abutment on the left side in FIG. 15 and the pawl 1028 is in the deployed position between two indentations 1016.

In the configuration illustrated in FIG. 15, the piston 1021 is in its end position and the pawl 1028 is in its deployed position.

In order to drive in rotation the carousel 1008 counterclockwise, pressurised air is injected into the chamber 1022 so as to move the piston 1021 according to the arrow I into its end position. During this movement, the bearing surface 1030 of the pawl 1028 abuts against the stop 1031 of the piston 1021 so that the pawl 1028 is blocked in rotation counterclockwise. The carousel 1008 is thus driven in rotation counterclockwise until the piston 1021 is in abutment in its end position. A new cell 1009 of the carousel 1008 is then in alignment with the loading jack 1006. During the movement of the carousel 1008, the blocking pin 8 slides against the peripheral surface of the carousel 1008 and is gradually moved from its blocking position in its unblocking position against the effect of the leaf spring 1027 then again in its locking position under the effect of the leaf spring 1027 so that the carousel 1008 is held stationary.

The jack 1020 is actuated according to the arrow J to return to its start position. During this movement, the pawl 2018 slides against the peripheral surface of the carousel 1008 and gradually passes from its deployed position to its retracted position then to its deployed position by rotating about the axis thereof.

The carousel 1008 can again be rotated counterclockwise by repeating this process.

The carousel 1008 and the pawls 1023, 1028 form ratchet wheel systems.

The first 1017 and second 1020 jacks as well as the corresponding pawls 1023, 1028 have antagonistic movements in that they allow driving in rotation the carousel 1008 in opposite directions.

The implementation of the first 1017 and second 1020 jacks allows putting the desired cell 1009 in line with the main spindle 51 more quickly by choosing the direction of rotation of the carousel 1008 which will allow the fastest putting in line. However, a single jack might be implemented. This will allow simplifying the device, but will induce longer alignment times.

The rotational drive means of the secondary carousel 1008 could be of the type of those of the main carousel 6, which are described later. In this case, rather than implementing single jacks to drive the pawls, double jacks could be implemented, i.e. external jacks containing an inner pawl blocking jack.

The indexing of the secondary carousel could also be obtained by means of a blocking pin controlled by a jack as for the main carousel.

This device comprises means for supplying the carousel with rivet. The rivets are brought through a flexible tube pushed inside this tube by a pressurised gas.

### Rivet Coating Station

The device comprises a coating device placed at a rivet coating station P4. This station allows depositing a sealing mastic on a rivet.

This coating station P4 is located in the vicinity of the workstation P5.

It comprises a first pulley 1032 which is movable in rotation about an axis essentially parallel to that of the main spindle 51 and connected in rotation by means of a belt 1033 with a drive pulley 1034 fastened to the main spindle 51 so that it is connected in rotation thereto along the axis of rotation thereof, but not in translation, for example by means of grooves.

This first pulley 1032 is connected in rotation to the casing of a jack 1036 along an axis essentially parallel to that of the main spindle 51. This casing is mounted movable in rotation relative to the rack along the same axis. The piston rod 1035 of the jack 1036 is connected in rotation with the casing.

This piston 1035 is mounted movable in translation and in rotation along an axis parallel to the axis of the main spindle 51 inside a chamber 1037. It carries at the end thereof a half-dog 1038 of complementary shape to the half- dog 211 of the rivet support module 200.

A second pulley 1039 is connected in rotation to the casing of the jack 1036 along an axis essentially parallel to that of the main spindle 51. This second pulley 1039 is connected in rotation by means of a belt 1040 to a third pulley 1041.

The third pulley 1041 is mounted on a shaft 1042 to which it is connected in rotation.

The shaft 1042 carries, at the end thereof opposite to that to which the pulley 1041 is fastened, a lead screw 1043.

This lead screw 1043 comprises a thread whose profile comprises a first flank 1044 intended to mesh with a shoe 1046 and a second flank 1045 inclined relative to the axis of the lead screw.

The first flank is inclined a few degrees relative to the perpendicular to the axis of the lead screw in such a way that, the shoe, being applied to this flank, has a tendency to slide towards the thread root.

This shoe 1046 is mounted on the end of the piston 1047 which is mounted movable in translation along an axis essentially orthogonal to the axis of the main spindle 51 in the chamber 1048 of a jack 1049.

The shoe 1046 is thus movable between at least:
a meshing position in which it meshes with lead screw 1043, and
a disengagement position in which it does not mesh with the lead screw 1043.

This station comprises mastic dispensing means comprising a nozzle 1050 connected to mastic supply means (not represented) comprising a pump connected, on the one hand, to a reserve of mastic and, on the other hand, to the nozzle 1050 via ducts provided for this purpose.

The nozzle 1050 comprises a dispensing end 1051 intended to come in the vicinity of a rivet 216 carried for a rivet support module 200 brought to the coating station P4. This end may be straight (extending in a plane perpendicular to an axis perpendicular to the axis of the rivet support module 200). However, this end is preferably bevelled or curved such that the nozzle 1050 can abut against the rivet 216 while forming an orifice for dispensing mastic onto the rivet 216. This solution is preferred insofar as it allows simply and effectively guaranteeing the calibration of the thread(s) of mastic deposited on the rivet.

The nozzle 1050 is secured to the end of a piston 1051 which is mounted movable in translation along an axis perpendicular to the axis of the rivet support module in the chamber 1052 of a jack 1053.

The shoe 1046, the nozzle 1050 and the respective jacks 1049, 1053 thereof are mounted in a block 1054 secured to the piston 1055 which is mounted movable in translation along an axis parallel to the axis of the lead screw 1043 in the chamber 1056 of a jack 1057.

This station comprises means for determining (evaluating) the length of the rivet 216 brought to the coating station. These means comprise a probe 1058. One end of the probe is secured to the piston 1059 which is mounted movable in translation along an axis parallel to the axis of the lead screw 1043 in the chamber (not represented) of a jack 1060. The other end of the probe 1058 comprises a conical centring tip 1061 oriented towards a rivet 216 brought to the coating station. The jack 1060 allows approaching and moving away the conical tip 1061 from the rivet 216 to probe the end thereof and thus determine its length. The probe 1058 then defines a stop against which the support 1062 of the nozzle 1050 is likely to bear in order to determine a coating limit at the end of the rivet. The term “end of the rivet” means a zone located at the end of the body of the rivet opposite to the head of the rivet.

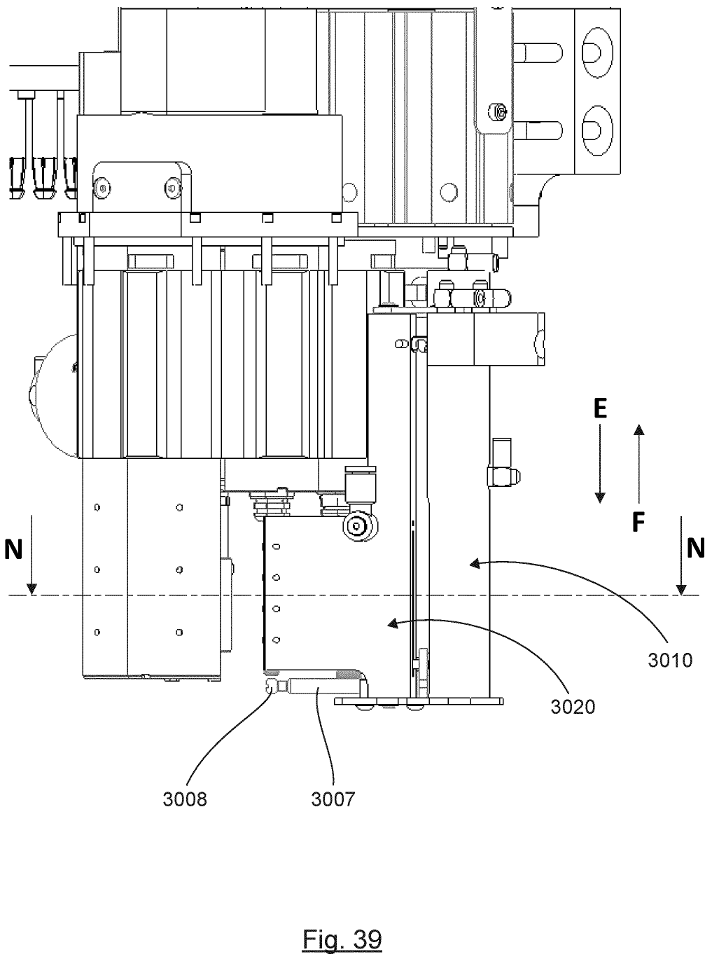

FIGS. 39 to 41 illustrate a variant of the coating station.

According to this variant, the nozzle 3000 is fixed relative to the frame and comprises:
a block 3001 provided with a borehole 3002 defining a chamber and with a plurality of distribution channels 3003 of coating material, these channels 3003 being in fluid communication with the chamber 3002 and opening via dispensing orifices 3004 formed along an axis substantially parallel to the axis of the body of the fastening element to be coated;
a drawer 3005 mounted movable in translation inside the chamber 3002, this drawer 3005 having a blind longitudinal groove 3006 on either side formed along said axis over a length enabling a fluid communication of the groove 3006 with all the channels 3003, the groove 3006 being connected to coating material supply means comprising for example a mastic pump whose outlet is connected by a pipe to the groove 3006.

A connector 3011 allows injecting mastic into one of the channels 3003, itself in communication with the groove 3006.

According to this variant, the probe 3007, which comprises an end 3008 provided to come into contact with the end (foot) of a fastening element, is at the opposite end thereof which is connected in translation with the drawer 3005.

The probe 3007 is further connected in translation with the piston 3009 of a jack 3010 whose axis extends essentially parallel to the axis of the main spindle 51.

In this manner, when the probe is in contact with the end of a fastening element, the channel(s) 3003 opening beyond this opposite end do not communicate with the groove 3006.

The channel 3003 located opposite to that located on the side of the end of a fastening element to be coated extends at the connection zone between the body and the head of this fastening element.

The nozzle thus allows dispensing mastic in the form of parallel beads on the body of a fastening element between the end thereof and the connection zone between the body thereof and the head thereof.

### Workstation

The workstation P5 is located in the extension of the main spindle 51.

This station allows carrying out different operations depending on the functional module brought thereto, in this case:
drilling and/or countersinking;
rivet setting;
temporary fastening setting.

This station comprises, in addition to the main spindle 51, a secondary spindle 170 mounted movable in translation inside the main spindle 51 which is hollow.

This secondary spindle 170 is secured to the piston 172 which is mounted to move in translation along the axis of the main spindle 51 in the chamber 171 of a jack 17. The secondary spindle constitutes the rod of this jack.

The workstation comprises coupling gear 16 of functional modules.

The coupling gear comprise means of the quick connection type.

In this embodiment, they comprise:
the bell 160 of certain functional modules comprising radial holes 161;
a male element 162 secured to the main drive spindle 51 and connected thereto, for the purposes of transmitting movement, and likely to be housed in the bell 160;
locking elements (balls or rollers) 163 secured to the male element 162 and located in the extension of the radial holes 161 when the male element 162 is housed in the bell 160: preferably, these locking elements comprise a cylindrical body provided to slide in radial holes 1620 of the male element 162 such that their end can be housed in the radial holes 161 of the bell 160, and a head in the shape of a portion of a sphere with a diameter which is larger than the cylindrical body to prevent them from being evacuated from the male element by the locking key;
a locking key 164 mounted movable in translation inside the male element 162 and comprising a circumferential ramp 165 likely to act against the locking elements 163 (in particular their cylindrical head) to move them inside the male element 162 until making them cooperate with the radial holes 162 of the bell 160 and thus making the bell and the male element secured in rotation and in translation.

The locking key 164 is secured to the end of the secondary spindle 170.

The locking key 164 is movable between at least two positions between which it can be moved by means of the jack 17, namely:
a coupling position in which it is close to the locking elements 163 such that the circumferential ramp 165 thereof acts on the locking elements 163 to cause them to slide inside the radial holes so that their ends form a protrusion outside the male element to be, where appropriate, housed in the radial holes 161 of a bell 160, and
an uncoupling position in which the locking key 164 is remote from the locking elements 163 such that it does not act thereon so that their ends do not protrude outside the male element to be, where appropriate, dislodged from the radial holes 161 of a bell 160.

Elastic return means can possibly be implemented to tend to return the locking elements 163 to their uncoupling position when the locking key does not act thereon.

The device comprises a pressurised air intake conduit 907 which opens at the workstation such that it communicates with the air conduit 906 of the sheath of a functional module located at the workstation.

### Telescopy

The secondary spindle 170 can allow carrying out a function of telescopy of different functional modules, such as in particular the rivet support modules.

This telescopy allows, as will be described in more detail later, bringing the secondary spindle 170, initially housed in the main spindle in a retracted position, to exit the main spindle 51 to reach a deployed position in which it extends at least partly outside the main spindle, then to connect them in translation such that the movement of the main spindle 51 is accompanied by a movement of the secondary spindle 170: the main spindle and the secondary spindle then form the same spindle of great length.

To this end, the secondary spindle 170 comprises, at the end thereof which is opposite to that of the locking key 164, the piston 172 movable in translation inside the main spindle 51 which constitutes the chamber 171 thereof of the jack 17.

The secondary spindle 170 comprises downstream of the piston 172 a circumferential groove 1063.

The device comprises means for connecting in translation said inner spindle with said outer spindle.

More specifically, the main spindle 51 carries an unlocking ring 1064.

This unlocking ring 1064 is fixed in translation with the frame. It is connected in rotation with the main spindle by means of grooves (not represented) which further allow the main spindle to translate inside the locking ring 1064. The locking ring 1064 is connected in rotation with the drive pulley 1034.

This unlocking ring 1064 comprises a borehole with a cylindrical portion 1065 followed by a frustoconical portion 1066 widening towards an opening which is opening on the side of the spindle 51 oriented towards a functional module brought to the workstation.

The main spindle 51 carries a locking member. This locking member comprises a locking ring 1067 mounted on the male element 162.

This locking ring 1067 is passed through by a hole 1068 whose diameter allows the passage of the locking key 164 and the secondary spindle 170.

This locking ring 1067 comprises a lateral actuation portion 1069 comprising:
a first outer peripheral groove portion 1070, and
an outer surface 1072 against which the unlocking ring 1064 is likely to act.

The locking ring 1067 has two opposite cut faces 1073 and is mounted in a complementary shaped groove 1074 formed in the male element 162.

The first groove portion 1070 forms, with a second peripheral groove portion 1070′ formed on the male element, a peripheral groove housing an elastic return element such as for example an O-ring or a spring.

The locking ring 1067 is movable in translation in the groove 1074 of the male element 162 along an axis orthogonal to the axis of the main spindle 51 between:
a locking position in which the actuating portion 1069 is brought closer to the axis of the male element 162 thanks to the action of the elastic return element, the peripheral end 1075 being engaged in the groove 1063 (or housing) made in the secondary spindle, and
an unlocking position in which the actuating portion 1069 is spaced apart from the axis of the male element 162, the peripheral end 1075 then being disengaged from the groove 1063 made in the secondary spindle.

The passage into the unlocking position is obtained by inserting the portion of the male element 162 carrying the locking ring 1067 into the conical portion 1066 then into the cylindrical portion 1065 of the unlocking ring 1064 which therefore acts on the locking ring 1067 to move it relative to the male element 162 against the effect of the compression spring.

It is then possible to translate the secondary spindle 170 inside the main spindle 51 between at least:
a retracted position in which it is housed inside said outer spindle, and
a deployed position in which it extends at least partly outside said outer spindle.

Passage into the locking position is obtained:
after extracting the male element 162 and the locking ring 1067 from the unlocking ring 1064, then
when the circumferential groove 1063 of the secondary spindle 170 reaches the level of the locking ring 1067, the latter passes into its locking position under the effect of the compression spring so that the locking end 1075 of the locking ring 1067 is housed in the groove 1063 of the secondary spindle 170 by getting closer to the axis of the male element 162.

The secondary spindle 170 is then connected in translation with the main spindle 51 so that the translational movement of the main spindle 51 is accompanied by a translational movement of the secondary spindle 170 which together form the same very long spindle.

### Rotational Drive of the Main Carousel

As mentioned above, the carousel is mounted movable in rotation about the axis thereof which extends essentially parallel to that of the spindle.

The carousel comprises, along the outer peripheral contour thereof, longitudinal indentations 62 which extend substantially parallel to the axis of the carousel. These indentations form drive teeth as will emerge more clearly later.

The device comprises means for driving in rotation the carousel about the axis thereof.

These rotational drive means comprise:
a first jack 70 comprising a piston 700 movable in translation in a chamber 701;
a second jack 71 comprising a piston 710 movable in translation inside a chamber 711.

The piston 700 of the first jack 70 carries a pawl 702 which is mounted movable in rotation relative to the piston 700 about an axis 703 essentially parallel to the axis of rotation of the carousel.

The pawl 702 comprises a bearing surface 704 provided to bear against a stop 705 of the piston 700 defining the extreme drive position.

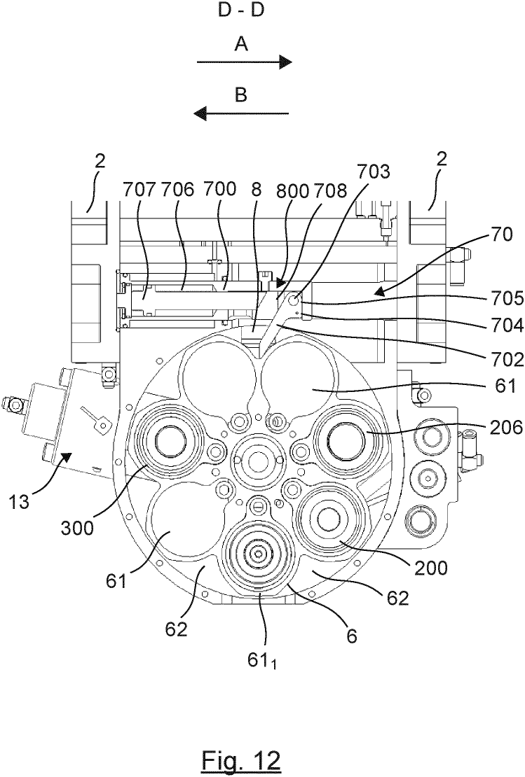

The pawl 702 is movable between two extreme positions, namely:
a deployed position in which its bearing surface 704 bears against the stop 705 of the piston 700 so that the end thereof is separated from the piston 700 and at least partially housed in an indentation 62 of the carousel (see FIG. 12), and
a retracted position in which the bearing surface 704 thereof is not bearing against the stop 705 of the piston 700 so that the end thereof is close to the piston 700 and clear of any indentation 62 of the carousel.

Return means (not represented), such as for example a spring or other, may possibly be implemented to act on the pawl to tend to return to its deployed position.

The piston 700 comprises an inner chamber 706 in which an internal piston 707, whose end 708 is bevelled, is housed.

This inner piston 707 is mounted movable in translation in the chamber 706 between:
an unblocking position in which the bevelled end 708 thereof is located away from the pawl 702 so as to leave the latter free to rotate about the axis 703, and
a blocking position, likely to be taken when the pawl 702 is in the deployed position thereof, in which the bevelled end 708 thereof bears against the pawl 702 in order to immobilise it in rotation about the axis 703.

The piston 700 is movable between two extreme positions, namely:
a starting position in which it abuts on the right side in FIG. 12 (insofar as the device can take any orientation in space, the indication of the right side is purely illustrative with reference to FIG. 12 for ease of understanding), and
an end position in which it abuts on the left side in FIG. 12 and the pawl 702 is in the deployed position between two indentations 62.

In the configuration illustrated in FIG. 12, the piston 700 is in its end position and the pawl is in its deployed position.

The device comprises a blocking pin 8 movably mounted between:
an indexing position in which it is brought into abutment against the carousel between two consecutive indentations 62 to prevent the rotation of the carousel about the axis thereof, and
a release position in which it is released from the carousel to allow its rotation.

An elastic return means, such as for example a spring (not represented), acts on the pin 8 to tend to return it to its blocking position. A jack 800 allows blocking the blocking pin 8 in its blocking position.

The blocking pin 8 constitutes means for blocking and indexing the carousel in positions in which at least one cell 61 of the carousel is at a functional station. In this embodiment, when the blocking pin 8 is in the blocking position in an indentation between two consecutive cells, several cells are in alignment with different functional positions, in this case:
a cell is located at the module loading/unloading station;
a cell is located at the temporary fastening loading station;
a cell is located at the rivet loading station;
a cell is located at the rivet coating station;
a cell is located at the workstation in the extension of the single spindle 51.

In order to drive in rotation the carousel counterclockwise, the jack 800 is exhausted so that the blocking pin 8 is held in its locking position by the sole effect of the spring.

The piston 700 is in its starting position (in abutment on the right in FIG. 12).

The pawl 702 is in its deployed position.

The internal piston 707 is in its blocking position so that the pawl 702 is maintained in its deployed position without being able to rotate about the axis thereof 703.

Pressurised air is then injected into the chamber 701 so as to move the piston 700 according to the arrow B from its start position to its end position.

During this movement, the pawl meshes with the notch in which it is located so that the carousel is thus driven in rotation counterclockwise. The blocking pin 8 slides against the peripheral surface of the carousel so that it gradually passes from its indexing position to its release position then from its release position to its indexing position when the piston 700 abuts in its end position. The jack 800 is powered to block the blocking pin in its indexing position so that the carousel is held stationary. At least one new cell 61 of the carousel is then at a functional station.

The internal piston 707 is moved into its unblocked position so that the pawl is free to rotate about the axis 703 (within the limit of the travel enabled by the shape thereof and the surfaces which surround it).

The jack 70 is actuated such that piston 700 moves according to the arrow A to be returned to its starting position.

During this movement, the pawl 702 moves progressively from its deployed position to its retracted position then from its retracted position to its deployed position by sliding against the peripheral surface of the carousel and by pivoting about the axis 703 clockwise until the piston is in its starting position. The pawl is then housed in another indentation 62 of the carousel.

The carousel can again be driven in rotation counterclockwise by repeating this process.

The piston 710 of the second jack 71 carries a pawl 712 which is mounted movable in rotation relative to the piston 710 about an axis 713 essentially parallel to the axis of rotation of the carousel.

The pawl 712 thus comprises a bearing surface 714 provided to bear against a stop 715 of the piston 710 defining the extreme drive position.

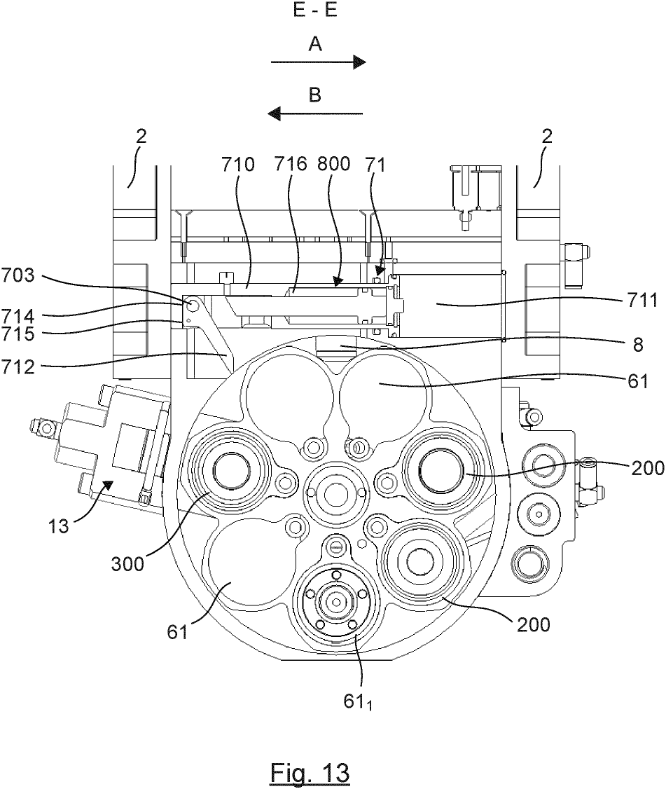

The pawl 712 is movable between two extreme positions, namely:
a deployed position in which the bearing surface 714 thereof bears against the stop 715 of the piston 710 so that the end thereof is housed in an indentation 62 of the carousel (see FIG. 13), and
a retracted position in which the end is close to the piston 710 and disengaged from any indentation 62 of the carousel (not represented).

Return means (not represented), such as a spring or other, may possibly be implemented to act on the pawl to tend to return to its deployed position.

The piston 710 comprises an inner chamber 716 in which an internal piston (not represented) is housed whose end is bevelled like the internal piston 707.

This internal piston is mounted movable in translation in the chamber between:
an unblocking position in which the end thereof is located away from the pawl so as to leave the latter free to rotate about the axis 713, and
a blocking position, likely to be taken when the pawl is in its deployed position, in which its bevelled end bears against the pawl in order to immobilise it in rotation about the axis 713.

The piston 710 is movable between two extreme positions, namely:
a starting position in which it abuts on the left side in FIG. 13 (insofar as the device can take any orientation in space, the indication of the right side is purely illustrative with reference to FIG. 12 for ease of understanding), and
an end position in which it abuts on the right side in FIG. 13 and the pawl is in the deployed position between two indentations 62.

In the configuration illustrated in FIG. 13, the piston 710 is in its starting position and the pawl 712 is in its deployed position.

In order to drive in rotation the carousel clockwise, the jack 800 is exhausted so that the blocking pin 8 is held in its locking position by the sole effect of the spring.

The piston 710 is in its starting position (in abutment on the left in FIG. 13).

The pawl 712 is in its deployed position.

The internal piston is in its blocking position so that the pawl is held in its deployed position without being able to rotate about the axis thereof 713.

Pressurised air is then injected into the chamber 711 so as to move the piston 710 according to the arrow A then its starting position to its end position.

During this movement, the pawl meshes with the indentation in which it is located so that the carousel is thus driven in rotation clockwise. The blocking pin 8 slides against the peripheral surface of the carousel so that it gradually passes from its indexing position to its release position then from its release position to its indexing position when the piston 710 abuts in its end position. The jack 800 is powered to block the blocking pin in its indexing position so that the carousel is held stationary. At least one new cell 61 of the carousel is then at a functional station.

The internal piston is moved into its unlocked position so that the pawl is free to rotate about the axis 713 (within the limit of the travel enabled by its shape and the surfaces which surround it).

The jack 71 is actuated so that piston 710 moves according to the arrow B to be returned to its starting position.

During this movement, the pawl 712 moves progressively from its deployed position to its retracted position then from its retracted position to its deployed position by sliding against the peripheral surface of the carousel and by pivoting about the axis 713 counterclockwise until the piston is in its starting position. The pawl is then housed in another indentation 62 of the carousel.

The carousel can again be driven in rotation clockwise by repeating this process.

The carousel and the pawls form ratchet wheel systems.

The first 70 and second 71 jacks as well as the corresponding pawls have antagonistic movements in that they allow driving in rotation the carousel in opposite directions.

The implementation of the first 70 and second 71 jacks allows placing a module at the desired functional position as quickly as possible by choosing the direction of rotation of the carousel which will allow ensuring the shortest path. However, a single actuator might be implemented. This will allow simplifying the device, but will induce longer alignment times.

The rotational drive means of the main carousel might be of the type of those of the secondary carousel. In this case, rather than implementing double jacks to drive the pawls, i.e. external jacks containing an internal jack for blocking the pawl, single jacks could be implemented.

The indexing of the secondary carousel could also be obtained by means of a blocking pin which is not controlled by a jack as for the secondary carousel.

The carousel 6 is mounted movable in rotation about a fixed shaft 8 on which it is guided in rotation by means of a needle, ball bearing 87 or other.

The shaft 8 is hollow and comprises, at one of the ends thereof, a widened portion defining a chamber 81 in which a piston 82 of a jack 80 slides.

The shaft 8 comprises, at the other of the ends thereof, a circumferential groove 83 and is passed through by a lateral lumen 84 communicating with the hollow interior of the shaft. The shaft further comprises, at this end, a flat section 85 which opens into the groove 83.

A guide element 14 is secured to the end of the rod 820 of the piston 82.

This guide element 14 comprises a portion forming a protrusion 140 which extends inside the lumen 84 of the shaft 8. A groove 141 is formed at the end of the portion forming a protrusion 140. This groove 141 extends in the extension of the groove 83 of the shaft with which it forms a circular groove.

The sheath 90 of each functional module is provided to be slidably mounted inside the cells 61 of the carousel 6.

The end of the lateral finger 900 of each of the sheath 90 of each functional module is provided to be housed according to the angular position of the carousel 6 alternately in the groove 83 of the shaft 8 and in the groove 141 of the guide element 14 such that the sheath is held secured the shaft 8 or the piston 82 along the axis of rotation of the carousel 6, and is thus immobilised in translation along the axis of the cell in which it is located.

The portion forming a protrusion 140 and the grooves 141 and 84 extend at an angular position corresponding to the finger 900 of a sheath 90 of a functional module 9 located at the workstation in the extension of the spindle 51.

The groove 901 of each sheath 90 is capable of housing the lug 10 placed at the end of the piston 11 which is movable in translation in the chamber 12 of the jack 13.

The jack 13 is located at a loading/unloading station of the carousel 6. This station is located such that when a cell 61 of the carousel is at the workstation in the extension of the spindle 51, another cell is located at the loading/unloading station (i.e. at the clip loading station in this embodiment), another cell is located at the rivet loading station and another cell is at the coating station.

The flat section 85 and the lug 10 extend along axes which are parallel and perpendicular to the axis of rotation of the carousel 6.

### Loading-Unloading of Functional Modules

The loading of the carousel 6 into functional modules 9 is obtained in the following manner.

Pressurised air is injected into the chamber 12 of jack 13 so as to move piston 11 according to the arrow C in order to release the lug 10 from inside the cell 61 located at the loading/unloading station.

The jack 1005 is actuated to place the fork 1003 in its release position.

A module is introduced inside the cell 61 located at the loading/unloading station by the side of the carousel 6 located on the side of the end of the shaft 8 where the groove 84 is located.

The finger 900 of the sheath 90 is introduced into the groove 83 by passing through the flat section 85 which forms an introduction passage.

Air is then introduced into chamber 12 of the jack 13 so as to move the piston 11 according to the arrow D to insert the lug 10 into the groove 901 of the sheath 90. The sheath 90, and therefore the corresponding functional module 9, is thus held in the cell 61 along the axis of which it is blocked in translation.

The shape of this groove 901 allows the sheath to arrive at the loading/unloading station and its departure from this station, while the lug 10 protrudes into the groove 901.

The carousel 6 can then be driven in rotation to place the next cell at the loading/unloading station and the process is repeated to load a new functional module 9.

It is thus possible to load the seven, or more generally all, the cells of the main carousel. However, only certain cells can be loaded as needed. It is also possible, in other embodiments, for the main carousel to comprise more or less than seven cells.

The unloading of a functional module 9 is obtained, after having placed the cell corresponding to the loading/unloading station, by actuating the jack 13 to disengage the lug 10 from the groove 901 and thus let the functional module 9 slide outside the corresponding cell 61.

### Pressing Element

The device comprises a pressing element 15 of tubular shape mounted movable in translation relative to the frame 2 along the axis of movement of the spindle 51 and in the extension thereof. Such a pressing element 15 can for example be used during a drilling operation to exert a compressive force on the structure to be drilled, in particular to ensure the contact between the plates of a stack and to avoid the formation of burrs between these plates during drilling.

### Setting Up the Multi-Task Device

The robot arm to which the device is secured is actuated to place the multi-task device so that the workstation is positioned at the location of the structure that is to be worked at which an operation is sought to be carried out.

The robot applies the device against the structure that is to be worked until the suction cups 41 bear against the surface thereof. The vacuum is then created in the suction cups to ensure an effective connection between the multi-task device and the structure that is to be worked.

A clamping C 42 can be used as an alternative to the suction cups.

### Drilling and/or Countersinking Operation

In order to carry out a drilling and/or countersinking operation, the main carousel is driven in rotation until the desired drilling module is at the workstation.

As a reminder, the elastic return means tend to return the piston 903 of the jack into a position in which the end 905 thereof is housed in the housing 950 or forms a protrusion in the sheath to prevent the functional assembly of the drilling module from sliding in the sleeve, the end 905 of the piston 903 coming into contact with the end 951 of the bearing 95.

The drilling and/or countersinking module 9 must then be coupled to the drive spindle 51 such that the latter can drive the movement the output shaft 91 which constitutes a mobile member of the module.

To this end, the spindle 51 is driven in translation along the axis thereof in the direction of the functional module placed at the workstation until the male element 162 is housed in the bell 160.

Pressurised air is injected into the chamber 171 of the jack 17 in order to move the internal spindle 170 according to the arrow E. The ramp 165 of the locking key 164 then acts on the locking elements 163 to place them in their coupling position in which they cooperate with the radial holes 161 of the bell 160. The spindle 51 and the output shaft 9 are then connected in rotation and in translation.

The angular position of the male element 162 relative to the bell 160 is random and consequently the locking elements may not be perfectly in line with the radial holes of the bell. The spherical heads of the locking elements allow inducing a slight relative rotation of the bell relative to the male element causing the holes of the bell and the male element to be co-axially placed and thus enabling the entry of the elements lock into the holes of the bell.

An excess number of holes in the bell relative to those of the male element facilitates this re-indexing.

If, however, the locking elements remained in balance between 2 holes without entering them, the resisting torque resulting from the first drilling operation would then induce a relative rotational movement of the male element and the bell to bring the locking elements in line with the radial holes and finalising the coupling.

The actuator 904 is actuated to extract the end 905 of the piston 903 thereof from the housing 950 of the bearing 95 or so that the end 905 no longer protrudes inside the sheath.

Pressurised air is then injected into the chamber 81 of the jack 80 in order to move the piston 82 according to the arrow E. Insofar as the mobile assembly abuts inside the sheath against the stop segment located on the side of the bell, the actuation of the jack 80 produces no effect. The main spindle 51 is then driven in translation along the arrow E. This has the following effects:
to translate the mobile assembly and the sheath along the arrow E
to urge the drive element 14 to follow the same movement so that the functional drilling module 9, whose finger 900 cooperates with the groove 141 of the drive element 14, is driven in translation along the arrow E along the axis of the spindle 51, until the sheath 90 bears against the pressing element 15.

The pressing element then follows the same movement, thus causing it to press against the structure that is to be worked and exert a pressure force on the structure that is to be worked.

The pressing force of the pressing element 15 against the surface that is to be worked is maintained by the actuator 80 while the translational movement of the spindle 51 along the arrow E is accompanied by a movement of the mobile assembly at the inside the sheath which is then stationary in translation along the arrow E.

The spindle 51 can then be driven in rotation and in translation and transmit its movements to the output shaft 91 of the coupled functional module 9 to carry out the desired drilling operation.

The coupling of the main spindle and the output shaft herein constitutes a connection in rotation and in translation.

By securing a screwing socket, rather than a cutting tool, to the module, it is possible to carry out a screwing/unscrewing operation.

### Rivet Loading

Prior to carrying out a rivet setting operation, whether or not preceded by a mastic coating operation, a rivet support module 200 must be loaded with a rivet 216.

To this end, the main carousel 6 is driven in rotation so as to bring, to the rivet loading station P3, the rivet support module 200 corresponding to the size of the rivet 216 that is desired to be set and if necessary coat.

Once the rivet support module 200 is brought to the rivet loading station P3, a rivet loading operation is implemented.

Previously, the cell 1009 of the secondary carousel 1008 corresponding to the size of this rivet 216 is supplied with a rivet by the means for supplying the carousel 1008 with rivets. The rivets are brought through a flexible tube pushed inside this tube by a pressurised gas.

The secondary carousel 1008 is then driven in rotation so as to place the cell 1009 containing the rivet at the rivet loading station P3.

Pressurised air is injected into the air conduit 906 of the rivet support module 200 so as to maintain the piston 205 thereof in its first extreme position in abutment against the circlip 218 on the side which is opposite to the split ring.

The jack 1006 is then implemented to push the rivet 216 contained in the cell 1009 inside the rivet support module 200 until the head 219 of the rivet 216 is housed in the split ring 213. during this movement, the head 219 of the rivet 216 acts on the split ring 213 to widen it so as to be housed in the groove 214 and in the conical borehole 215 of the split ring 213. The ring 213 then tightens around the head 219 of the rivet 216 under the effect of the O-rings implemented for this purpose so that the rivet 216 can no longer come out of the ring 213 following the opposite path. The rivet 216 is then held in the rivet support module 100 and the body 220 thereof forms a protrusion outside the module 200 beyond the split ring 213.

### Rivet Coating Operation

In order to carry out a rivet coating operation, the rivet support module 200 previously loaded with the rivet 216 which it is desired to coat with mastic is brought to the coating station P4 by rotating the main carousel 6.

During this movement, the piston 205 of the rivet support module remains in abutment against the circlips 218 under the effect of the friction of the O-rings ensuring the sealing of the chamber.

It is possible to carry out a coating of the helical type, or a coating of the annular type or even a coating of parallel annular beads.

### Helical Coating

A coating of the helical type consists in depositing at least one annular bead of mastic at the end 221 of the rivet, at least one annular bead of mastic under the head 219 of the rivet and a helical bead along the body 220 of the rivet between the end and the head of the rivet.

To this end, the procedure is as follows.

Prior to the arrival at the station for coating a rivet support module:
the jack 1053 is actuated to maintain the end of the nozzle 1050 in its extreme position in which it is furthest from the body 220 of the rivet 216;
the jack 1047 is actuated so as to hold the shoe 1046 in its disengagement position;
the jack 1060 is actuated such that the probe 1058 is in its extreme position on the side of the end 221 of the rivet 216;
the jack 1057 is actuated such that the block 1054 carrying the shoe 1046 and the nozzle 1050 is in its extreme position on the side of the end 221 of the rivet 216.

The support 1062 of the nozzle 1050 then abuts against the probe 1058.

The jack chamber 1057 carrying the block 1054 is exhausted.

The jack 1036 is actuated so as to engage the half-dog 1038 which it carries with the half-dog 211 of the piston of the rivet support module 100 placed at the coating station. The piston herein constitutes a mobile member and the cooperation of the two half-dogs constitutes an indirect coupling of the main spindle with this mobile member. The coupling is herein a rotational connection.

The half-dog 1038 carried by the jack 1036 then moves the piston 205 of the rivet support module 100 in the direction of the probe 1058. When the jack 1036 reaches the end-of-stroke, the piston 205 of the module is placed such that the connection zone between the head 219 and the body 220 of the rivet carried by the module is at a given position. It should be noted that each rivet support module is adapted to support a rivet of a given size. The length along the axis of the spindle 51 of the piston 205 of each rivet support module is determined depending on the size of the rivet that it is intended to support such that, when the jack 1036 carrying the half-dog 1038 arrives at the end-of-stroke, the connection zone between the head 219 and the body 220 of the rivet carried by a module is always at the same given position along the axis of the spindle 51.

The jack 1060 is actuated to move the probe 1058 in the direction of the head 219 of the rivet until the conical tip 1061 bears against the end 221 of the rivet thus stopping the stroke of the jack 1060.

The probe 1058, against which the nozzle 1050 abuts, thus moves the nozzle at the end 221 of the rivet (at a predetermined distance from the end of the rivet).

The jack 1053 moves the nozzle 1050 towards the body 220 of the rivet until the end thereof comes into contact with the rivet body.

The main spindle 51 is driven in rotation so as to drive in rotation via the pulleys and belts, on the one hand, the piston 205 of the module and therefore the rivet that it carries, but also the lead screw 1043 at time t0.

At the same time, the mastic pump is implemented such that the nozzle 1050 delivers mastic at the end 221 of the rivet.

After a period corresponding to one turn of the lead screw 1043, the shoe 1046 is moved towards its meshing position with the lead screw 1043 by means of the jack 1049.

The contact between the shoe 1046 and the surface 1045 of the thread 1044 of the lead screw 1043 is finalised after a fraction X of a turn of the lead screw 1043. This fraction of a turn is necessary insofar as when the shoe comes into contact with the screw, it is in a random relative position such that a space between the shoe and the flank of the thread remains. Thus, the drive in translation of the shoe by the lead screw is effective only after this space has been resorbed under the action of a random fraction of a turn X.

At this stage, a bead of mastic of 1 + X turn has been deposited at the end 221 of the rivet.

When the shoe 1046 is in its meshing position, i.e. after finalising the contact between the shoe and the lead screw, the nozzle 1050 then begins to move towards the head 219 of the rivet and the nozzle 1050 begins to deposit a spiral bead of mastic along the rivet body 220.

When the piston 1055 of the jack 1057 carrying the block 1054 comes into abutment by being moved from the end 221 towards the head 219 of the rivet, the nozzle 1050 reaches the height of the connection between the body 220 and the head 219 of the rivet.

The rotation of the single spindle 51 is stopped after a time elapsed from t0 allowing a number of turns of the lead screw of 3 + Y, Y being the number of turns of the spiral between the bead on the end and the bead under the head of the rivet. Knowing the rivet length allows knowing the distance Z between the end and head beads, Y = Z / lead screw pitch (assuming herein that the rivet to be coated and the lead screw turn at the same frequency).

The length of bead deposited on the end, which can be 2 turns at most, justifies the total number of turns of 3 + Y to have at least a deposit of 1 turn under the head.

At the same time as the main spindle 51 is stopped in rotation, the deposition of mastic is deactivated by depressurising the mastic pump.

At the time of stopping the single spindle 51, a 2 - X turn bead of mastic was deposited under the rivet head (3 turns minus (1 + X)).

The shoe 1046 is moved into its disengagement position thanks to the jack 1049.

The nozzle 1050 is moved away from the rivet body 220 thanks to the jack 1053.

The nozzle 1050 and the probe 1058 are brought into the extreme position on the side of the end 221 of the rivet respectively thanks to the extension of the jacks 1057 and 1060.

The main carousel 6 is driven in rotation to bring the rivet coated with mastic to the rivet setting station at which a rivet setting device is located.

### Annular Coating

An annular-type coating consists in depositing at least one annular bead of mastic under the head 219 of the rivet.

To this end, the procedure is as follows.

Prior to the arrival at the coating station of a rivet support module 100:
the jack 1053 is actuated to hold the end of the nozzle 1050 in its extreme position in which it is furthest from the body 220 of the rivet;
the jack 1049 is actuated so as to hold the shoe 1046 in its disengagement position;
the jack 1060 is actuated such that the probe 1058 is in its extreme position on the side of the end 221 of the rivet.

The jack 1036 is actuated so as to engage the half-dog 1038 which it carries with the half-dog 211 of the rivet support module 100 placed at the coating station.

The half-dog 1038 then moves the piston 205 of the rivet support module 100 in the direction of the probe 1058. When the jack 1036 reaches the end-of-stroke, the piston 205 of the module is placed such that the connection zone between the head 219 and the body 220 of the rivet carried by the module 200 is at a given position. It should be noted that each rivet support module is adapted to support a rivet of a given size. The length along the axis of the spindle of the piston of each rivet support module is determined depending on the size of the rivet that it is intended to support such that, when the jack carrying the half-dog clutch reaches the end-of-stroke, the connection zone between the head and the body of the rivet carried by a module is always at the same given position.

The jack 1060 is actuated to move the probe 1058 in the direction of the head 219 of the rivet until the conical tip 1061 comes to bear against the end 221 of the rivet thus stopping the stroke of the jack 1060.

The jack 1057 is actuated to come into abutment, at the end thereof, on the side of the head 219 of the rivet thus stopping the nozzle 1050 at the height of the connection between the body 220 and the head 219 of the rivet.

The jack 1053 moves the nozzle 1050 towards the rivet body 220 until the end thereof comes into contact with the rivet body 220.

The main spindle 51 is driven in rotation so as to drive in rotation, via the pulleys and belts, on the one hand the piston 205 of the module and therefore the rivet it carries.

At the same time, the mastic pump is implemented such that the nozzle 1050 delivers mastic at the connection zone between the head 219 and the body 220 of the rivet.

The rotation of the main spindle 51 is stopped after having imparted a rotation of at least one turn to the rivet, at this stage a bead of at least one turn is deposited under the rivet head 219.

At the same time, the mastic deposition is deactivated by depressurising the mastic pump.

The nozzle 1050 is moved away from the body 220 of the rivet thanks to the retraction of the jack 1053.

The nozzle 1050 and the probe 1058 are brought into the extreme position on the side of the end 221 of the rivet respectively thanks to the extension of the jacks 1057 and 1060.

The main carousel 6 is rotated to bring the mastic coated rivet to the work station to set the rivet.

### Coating With Parallel Annular Beads

A coating of a rivet with parallel annular beads of mastic between the end thereof and the zone for connecting the body thereof with the head thereof is obtained as follows.

The jack 3010 is actuated to move probe 3008 along the arrow E to its extreme position.

A rivet support module carrying a rivet to be coated is then brought to the coating station.

The half-dog 1038 is moved to the stop by the corresponding jack so as to be engaged with the half-dog 211 of the module and to move the piston of the module into a position in which the connection zone of the rivet that it carries is in alignment with the channel 3003 of the nozzle located opposite to that located on the side of the end of the rivet.

The jack 3010 is actuated along the arrow F so that end 3008 of the probe comes into contact with the end of the rivet.

The drawer 3005 then slides inside the chamber 3002 so as to close the channels which extend beyond the end of the rivet.

The rivet is then driven in rotation on one turn while the mastic pump is implemented to dispense mastic. This allows simultaneously depositing, on the body of the rivet, a plurality of annular beads of mastic parallel between the end and the connection zone of the rivet.

Once the beads have been deposited, the rotation of the rivet is stopped, the pump is stopped, the jack is actuated according to the arrow E to move the probe away from the rivet, then the main carousel is actuated to move the module carrying the coated rivet to the workstation to set the rivet.

### Rivet Setting Operation

The device can be implemented to carry out the setting of rivets, previously coated or not with mastic, depending on the case. It therefore comprises a rivet setting device.

After the arrival at the workstation P5 of a rivet support module 200 carrying a rivet, the setting of the latter, in a hole previously made in the structure that is to be worked, is obtained in the following manner.

The main spindle 51 is driven in translation along the axis thereof via the feed motor.

The main spindle 51 then bears against the piston 205 of the rivet support module 200 so that the latter moves in translation inside the chamber from a retracted position in which it extends inside the sheath towards a deployed position in which it extends at least partially outside the sheath until it comes into abutment at the bottom thereof and that the sheath translates into the cell of the carousel over a sufficient distance to engage the end 221 of the rivet in the corresponding hole (in the case of a rivet with a threaded end, the insertion of the threaded portion may be sufficient).

The piston of the module constitutes a mobile member and the coupling herein constitutes a simple contacting of the main spindle with the mobile member so as to drive it in translation in one direction.

The feed motor is then driven so as to move the main spindle 51 in the opposite direction.

During this movement of the main spindle, the piston 205 of the rivet support module remains stationary inside the chamber thereof under the effect of friction.

The main spindle 51 is translated until it reaches its extreme position in which the portion of the male element 162 carrying the locking ring 1067 is housed in the cylindrical portion 1065 of the unlocking ring 1064 which acts on the unlocking ring 1067 to move it into its unlocking position.

The secondary spindle 170 is then translated inside the main spindle 51 by supplying the chamber of the jack 17 thereof (until it comes into contact with the head of the rivet).

During this output of the secondary spindle, the circumferential groove 1063 passes through the unlocking ring 1064.

Then the main spindle 51 is advanced, the portion of the male element 162 comes out of the cylindrical portion 1065, thus the unlocking ring is again pressed against the secondary spindle and when this ring again arrives at the circumferential groove 1063, it is housed in the groove 1063 under the action of the elastic return element.

The secondary spindle 170 is then connected in translation with the main spindle 51 so that the translational movement of the main spindle 51 is accompanied by a translational movement of the secondary spindle 170 which together form a long spindle.

The locking key 164 then pushes on the head 219 of the rivet to extract it from the clamp and insert it completely into the hole.

The rivet is thus evacuated from the module by evacuation means which allow inserting it into a hole and which comprise, in this embodiment, in particular the main and secondary spindles.

Reading the currents of the motors driving the main spindle, in this case the feed motor, allows knowing the thrust effect on the rivet and stopping the progress of the main spindle when the thrust effect becomes greater than a predetermined threshold corresponding to a total insertion of the rivet in the hole thereof.

This approach allows ensuring effective positioning of a rivet with greater efforts than if the positioning was carried out with the central jack implemented to control the pressing element 15 and with a better accuracy, taking into account the forces of thrust recorded at the main spindle.

Once the rivet has been correctly inserted into the hole, the main spindle 51 is moved to its extreme position in which the portion of the male element 162 carrying the locking ring 1067 is housed in the cylindrical portion 1065 of the unlocking ring 1064 which thereby acts on the outer surface of the actuating lateral portion 1069 to move the locking ring 1067 relative to the male element 162 against the effect of the compression spring in its unlocked position.

The secondary spindle 170 is then retracted into the main spindle 51 by actuating the jack 17 thereof.

Finally, the piston 205 of the rivet support module is retracted into the sheath by supplying the chamber thereof with compressed air until it abuts against the circlips 218 and the sheath 90 is retracted into the cell thereof thanks to the action of the jack 80.

### Temporary Fastening Loading

A device according to the invention can be implemented to carry out the setting of temporary fastenings.

A temporary fastening 2000 conventionally comprises a body 2001, a deformable end 2002 (expandable and retractable) in the shape of a spear point having a longitudinal slot and containing a spacer element fixed relative to the body, and a rotary element 2003 which when it is rotated relative to the body, causes the spacing (expansion) of the spear then its retraction in the body. Thus when, after having been introduced into a hole passing through 2 sheets, the rotary element is turned and tightened relative to the body, the spear deviates from the other side of the sheets relative to the body then retracts into the body and causes the plating of the sheets one over the other. An illustrative and non-limiting example of temporary fastening is described in document US 4 548 533.

The temporary fastenings according to the invention comprise a body and a rotary element of cylindrical section and of the same diameter and having smooth and uniform outer surfaces. The body and the rotary element are separated by a space (housing) to allow them to be locked in position as will be described in more detail elsewhere.

Prior to carrying out a temporary fastening setting operation, a temporary fastening support module 300 must be loaded with a temporary fastening.

To this end, the main carousel 6 is driven in rotation so as to bring the temporary fastening support module to the loading station P2.

After the temporary fastening support module is brought to the temporary fastening loading station, a temporary fastening loading operation is implemented.

The jack 1005 is actuated to place the fork 1003 in its holding position.

The bandolier 1000 is implemented to place a temporary fastening 2000 in the axis of the temporary fastening support module.

The chamber of the temporary fastening support module is supplied with compressed air so as to maintain the piston 306 in a release position in which the shoulder 307 thereof is close to the flange 314 of the drive tube 313. In this position, the surface of the conical borehole 331 of the piston 306 acts on the locking element 321 to hold it in its rest position in which the end of the locking lug 32 is away from the longitudinal axis of the drive tube.

The loading jack 1002 is activated so that the end of the rod thereof comes out of the chamber thereof to push the head of the rotary element 2003 of the temporary fastening so as to insert the temporary fastening into the temporary fastening support module until the female portion 2001 abuts against the fork 1003.

The rotary element 2003 of the temporary fastening is then engaged with the first freewheel 318 while the body 2001 is engaged with the second freewheel 33′.

The chamber of the temporary fastening support module is vented to atmosphere so that the piston 306 moves away from the flange 314 under the effect of the spring 315 until reaching a locking position. During this movement, the locking element 321 returns to its locking position under the effect of the spring housed in the housing 328: the end of the locking lug 327 is then housed in the space E between the head of the rotary element 2003 and the body of the temporary fastening so that it is blocked in translation inside the module along the longitudinal axis thereof.

The loading jack 1002 is then retracted to its starting position then the jack 1005 is actuated so as to return the fork 1003 to its release position.

### Temporary Fastening Operation

The device allows setting temporary fastenings and thus comprises a temporary fastening setting device.

In order to carry out the setting of a temporary fastening, a temporary fastening support module, in which a temporary fastening has been inserted, is brought with the main carousel to the workstation.

The temporary fastening support module must then be coupled to the main spindle.

To this end, the spindle 51 is driven in translation along the axis thereof in the direction of the functional module placed at the workstation until the male element 162 is housed in the bell 160.

A slight air pressure can be introduced into the chamber of the module so that the piston 306 exerts a counter force along the longitudinal axis of the module vis-à-vis the coupling force.

Pressurised air is injected into the chamber 171 of the jack 17 in order to move the internal spindle 170 according to the arrow E. The ramp 165 of the locking key 164 then acts on the locking elements 163 to place them in their coupling position in which they cooperate with the radial holes 161 of the bell 160. The spindle 51 and the drive tube are then connected in rotation and in translation. The drive tube is a mobile member and the coupling of the latter with the main spindle is a connection in rotation and in translation.

In order to insert the temporary fastening into the hole in the structure that is to be worked:
the feed motor is implemented to translate the main spindle 51 so as to slide the drive tube 313 and thereby the piston 306 inside the module,
the jack 80 and the compressed gas supply to the temporary fastening support module via the conduit 906 are exhausted until the descent of the spindle 51 has allowed the insertion of the temporary fastening in the housing thereof of the workpiece;
the continuous feed motor is implemented to translate the main spindle 51 so as to continue to slide the drive tube 313 and thereby the piston 306 inside the module until that the thrust, recorded at the main spindle 51 by the sensor of current consumed by the feed motor, reaches a predetermined threshold value corresponding to the abutment of the temporary fastening against the structure that is to be worked.
The main spindle 51 is driven in rotation by means of the rotation motor so that the drive tube drives in rotation the head of the male part of the temporary fastening. Given the antagonistic operation of the freewheels, the male portion of the temporary fastening rotates while the female portion is held stationary in rotation. As a result, the male portion is screwed causing the expansion of the deformable end in the hole and thus the securing of the temporary fastening in the hole of the structure that is to be worked.
When the tightening torque determined by the rotation motor current sensor reaches a predetermined threshold value corresponding to the completion of the tightening of the temporary fastener, the rotation motor is stopped.
The rotation motor is driven in rotation in the other direction so as to drive in rotation the main spindle 51 to some degree in order to disengage the freewheels of the module.
Air is introduced into the conduit 906 to move the piston to its release position and place the locking lug in its rest position.
The feed motor is implemented to move the spindle 51 to its original position.
The main spindle is stopped when the drive tube is in its initial position.
The jack 820 is activated to replace the sheath into its original position.
The jack 17 is actuated to release the locking elements 163 from the radial holes 161 of the bell 160 and thus uncouple the main spindle 51 from the drive tube 313 of the module.
The feed motor is again implemented to return the main spindle into abutting engagement into its initial start position.
the temporary fastening support module can then be led again to the temporary fastening loading station in order to receive a new temporary fastening to be set up.

### Variants

In the case of drilling modules, the coupling between the spindle and the mobile member, i.e. the output shaft or the drive tube, is direct. Indeed, the spindle and the output shaft or the drive tube are interconnected directly via the coupling gear 16 without intermediate gearing system. An intermediate gearing system could however be interposed between the mobile member and the bell 160. Such an intermediate gearing system could or could not be uses as a reduction gear. It could not induce movement transformation or on the contrary induce a movement transformation (for example transformation of a translational movement of the spindle into a rotational movement of at least one mobile member of a functional module).

In the case of the rivet support module, the coupling between the mobile member (the piston of the module) and the spindle is done indirectly at the coating station via the pulleys, belts and half-dogs. It is done directly by simple contact at the workstation.

The examples of functional modules described herein only comprise a mobile member, i.e. the output shaft, piston, drive tube. It could, however, comprise several output members.

During the performance of an operation, the sensors of the control and measurement assembly can allow detecting parameters specific to the operation of the coupled module.

During a drilling operation, the following parameters can be measured, for example:
axial thrust on the drill bit: deduced for example from a force sensor on the spindle or in the gearing system or from the intensity of the current for powering the feed motor;
torque on the drill bit: deduced for example from a torque sensor on the spindle or in the gearing system or from the intensity of the current for powering the rotation motor;
stroke of the drill bit: for example deduced from the angle sensor of the feed motor.

During a screwing operation, the following parameters can be measured, for example:
screw stroke: deduced for example from the angle sensor of the rotation motor;
tightening torque: for example deduced from the torque sensor in the gearing system or from the intensity of the rotation motor.

During a rivet setting operation, for example, it is possible to measure:
the axial thrust on the rivet: deduced for example from a force sensor on the spindle or in the gearing system or from the intensity of the current for powering the feed motor.
the axial stroke of the rivet: deduced for example from the angle sensor of the feed motor.

During a temporary fastening setting operation, the following parameters can be measured, for example:
axial thrust on the temporary fastening: deduced for example from a force sensor on the spindle or in the gearing system or from the intensity of the current for powering the feed motor;
tightening torque: for example deduced from the torque sensor in the gearing system or from the intensity of the rotation motor.

The axial thrust measurement can also be used to detect the cooperation of the male element 162 and the bell 160 during the coupling of a functional module.

Of course, this does not represent an exhaustive list of the possible parameter measurements.

All sensors and other measurement means are integrated into the control and measurement assembly 5. The functional modules therefore preferably do not comprise any sensor, or at the very least a very limited number of sensors, which makes their structure particularly simple, robust and economical.

The device also comprises a battery of pneumatic connectors 18 allowing connecting all the pneumatic actuators to pressurised fluid supply means and/or to means for creating a vacuum.

Several operations can be implemented simultaneously at different stations, for example:
a drilling or rivet setting or temporary fastening setting operation can be carried out at the workstation;
a rivet loading operation at the rivet loading station;
a temporary fastening loading operation at the temporary fastening loading station.

The device according to the invention allows carrying out a plurality of functions, for example setting of a fastening element, coating of a fastening element, drilling... In this sense, it constitutes a multi-task device. It thus comprises devices allowing carrying out each of the functionalities, in particular coating device, temporary fastening setting device, fastening element setting device, drilling device, fastening element transfer device... Each of these devices can be dissociated to form an independent device ensuring its own function. Any combination of several (in particular at least 2) of these devices can be made.

An exemplary embodiment of the present disclosure provides an effective solution to at least some of the different problems of the prior art.

In particular, an embodiment provides a versatile device which can allow carrying out tasks of different types without therefore the need for carrying out an operation for changing tooling between two different tasks to set up the necessary tooling.

An embodiment provides such a device which is compact and/or light, and which consequently allows carrying out tasks in cramped spaces.

An embodiment provides such a device which is simple in design.

An embodiment provides such a device which is simple to maintain.

In an exemplary embodiment, such a device which is relatively inexpensive.

Although the present disclosure has been described with reference to one or more examples, workers skilled in the art will recognize that changes may be made in form and detail without departing from the scope of the disclosure and/or the appended claims.

1. A multi-task device comprising:
means for securing said device to motorised handling means able to move said multi-task device at least partially in space with respect to a structure that is to be worked;
means for securing said device to said structure that is to be worked;
at least two functional modules, each of said functional modules comprising at least one mobile member able to allow a given task to be accomplished;
said device comprising a single drive and control assembly for driving and controlling said functional modules, said drive and control assembly comprising:
a single drive spindle;
drive means capable of driving the movement of said spindle;
measurement means for measuring at least one physical parameter indicative of at least one characteristic of operation of said functional modules;
control means for controlling said drive means and said measurement means;
said device further comprising coupling gear able to connect said single drive spindle, for the purposes of transmitting movement, alternately to said at least one mobile member of said functional modules.

2. The device according to claim 1, wherein said coupling gear ensure a direct connection between said spindle and said at least one mobile member of the coupled functional module.

3. The device according to claim 1, comprising means for transforming movement between said spindle and said at least one mobile member of said coupled functional module.

4. The device according to claim 1, wherein said motorised handling means belong to the group comprising consisting of:
robot;
a digital drilling grid.

5. The device according to claim 1, wherein said measurement means are configured to measure at least one parameter indicative of at least one characteristic of operation of said functional modules belonging to the group consisting of:
a torque on said at least one mobile member of the coupled module;
an axial force on said at least one mobile member of the coupled module;
an angular position of said at least one mobile member of the coupled module;
an axial position of said at least one mobile member of the coupled module.

6. The device according to claim 1, wherein said drive means comprise at least one electric motor capable of driving the movement of said spindle and said at least one mobile member of a functional module coupled to said spindle.

7. The device according to claim 6, wherein said control means comprise means for measuring the electrical intensity consumed by said motor and means for determining, depending on the measured electrical intensity, a torque and/or an axial force on said at least one mobile member of a coupled module.

8. The device according to claim 6, wherein said at least one motor comprises a rotor, said measurement means comprising at least one sensor for measuring an angular position of said rotor, said control means comprising means for determining, depending on the angular position of said measured rotor, an angular position and/or an axial position of said at least one mobile member of a functional module coupled to said spindle.

9. The device according to claim 6, wherein said drive means comprise a gearing system connecting said at least one motor to said single drive spindle, said measurement means comprising at least one torque and/or force and/or position sensor which are integrated into said gearing system capable of allowing the-determination of a torque and/or an axial force on said at least one mobile member of a coupled module and/or of an angular and/or axial position of said at least one mobile member of a coupled module.

10. The device according to claim 1, comprising means for routing said functional modules in an extension of said drive spindle.

11. The device according to claim 10, wherein said means for routing comprise at least one carousel which is mounted movable in rotation and comprising means for supporting a plurality of functional modules.

12. The device according to claim 11, comprising rotational drive means for driving in rotation said at least one carousel, said rotational drive means comprising at least one mobile drive pawl forming with said carousel a ratchet wheel type assembly, said rotational drive means comprising means for moving said mobile drive pawl along an axis orthogonal to the axis of rotation of said carousel.

13. The device according to claim 10, wherein said means for routing comprise at least one support member which is movable in translation and comprising means for supporting a plurality of functional modules.

14. The device according to claim 1, comprising means for remotely activating-deactivating said coupling gear.

15. The device according to claim 1, wherein said drive spindle is mounted movable in rotation and in translation along a same axis, said drive means comprising at least one motor and one gearing system connecting said drive spindle to said at least one motor, said gearing system comprising:
a rotational drive yoke comprising a splined portion of complementary shape to a splined portion formed on said spindle along said axis;
a translational drive ring connected to said drive spindle by a helical connection along said axis.

16. The device according to claim 1, comprising at least one pressing element, capable of exerting a pressure on said structure that is to be worked, located in an extension of said drive spindle, and means for moving said pressing element in the direction of said structure that is to be worked, said means for moving said pressing element acting on said pressing element via a functional module located in the extension of said spindle.

17. The device according to claim 1, wherein at least one of said functional modules comprises a sheath slidably housing a functional assembly, said functional assembly further comprising means for blocking in translation said functional assembly in said sheath.
